(19) United States
(12) Patent Application Publication
(10) Pub. No.: US 2012/0032891 A1
(43) Pub. Date: Feb. 9, 2012

(54) Device, Method, and Graphical User Interface with Enhanced Touch Targeting

(76) Inventor: Nima Parivar, South San Francisco, CA (US)

(21) Appl. No.: 12/849,769

(22) Filed: Aug. 3, 2010

(51) Int. Cl. G06F 3/041

(52) U.S. Cl. 345/173

(57) ABSTRACT

An electronic device has a touch-sensitive display and one or more touch-sensitive surfaces that are distinct from the touch-sensitive display. The device displays one or more user interface objects on the touch-sensitive display, and detects one or more user contacts on the one or more touch-sensitive surfaces. While detecting the one or more user contacts on the one or more touch-sensitive surfaces, the device also detects one or more finger contact areas at respective locations on the touch-sensitive display. For each finger contact area, the device determines a respective finger contact coordinate tuple based at least in part on: a respective location of a respective finger contact area, and the user contacts on the one or more touch-sensitive surfaces. The device manipulates at least one of the one or more user interface objects in accordance with the respective finger contact coordinate tuples.

### TECHNICAL FIELD

This relates generally to electronic devices with touch-sensitive displays, including electronic devices with touch-sensitive surfaces that are distinct from the touch-sensitive displays.

### BACKGROUND

The use of touch-sensitive displays as input devices for electronic computing devices has increased significantly in recent years. Touch-sensitive displays are widely used to manipulate user interface objects on such displays.

Exemplary manipulations include adjusting the position and/or size of one or more user interface objects, as well as activating one or more user interface objects. Exemplary user interface objects include digital images, video, text, icons, and other graphics. A user may need to perform such manipulations on user interface objects in various applications, or on a home screen.

For touch-sensitive displays, the detected contact area of a finger is typically converted to a coordinate tuple (an (x, y) position or point). The coordinate tuple is then used (like the point of a cursor in a device with mouse-based input) to interact with and manipulate the user interface objects on the touch-sensitive display. With existing touch targeting methods, the conversion of the two-dimensional finger contact area to a one-dimensional point (e.g., coordinate tuple) is problematic. The centroid of the finger contact area typically does not correspond to the location that a user perceives is being touched. This may cause touch targeting errors when trying to activate keys on a virtual keyboard or interact with other objects on the touch-sensitive display. The change in viewing parallax in different areas of the touch screen and the differences in contact areas between thumbs and other fingers may also lead to touch targeting errors and incorrect manipulations. Undoing erroneous manipulations and repeating touch inputs creates a significant cognitive burden on a user and may lead to user frustration. In addition, correcting touch inputs takes additional time, thereby wasting energy. This latter consideration is particularly important in battery-operated devices.

### SUMMARY

Accordingly, there is a need for electronic devices with touch-sensitive displays that have more accurate and more efficient methods and interfaces for determining a coordinate tuple of a touch-based input that corresponds to a user's intended input. Such touch targeting methods and interfaces reduce the cognitive burden on a user and produce a more efficient human-machine interface. For battery-operated computing devices, such methods and interfaces conserve power and increase the time between battery charges.

The above deficiencies and other problems associated with user interfaces for electronic devices with touch-sensitive displays (also known as “touch screens” or “touch screen displays”) are reduced or eliminated by the disclosed devices that also include touch-sensitive surfaces that are distinct from the touch-sensitive displays. In some embodiments, the device is a desktop computer. In some embodiments, the device is portable (e.g., a notebook computer, tablet computer, or handheld device). In some embodiments, the device is a desktop computer that includes a portable input/display device connected to the desktop computer. In some embodiments, the device has a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. In some embodiments, the functions may include image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions may be included in a computer readable storage medium or other computer program product configured for execution by one or more processors.

In accordance with some embodiments, a method is performed at an electronic device with a touch-sensitive display and one or more touch-sensitive surfaces that are distinct from the touch-sensitive display. The method includes: displaying one or more user interface objects on the touch-sensitive display; and detecting one or more user contacts on the one or more touch-sensitive surfaces that are distinct from the touch-sensitive display. The method also includes, while detecting the one or more user contacts on the one or more touch-sensitive surfaces that are distinct from the touch-sensitive display, detecting one or more finger contact areas at respective locations on the touch-sensitive display. The method furthermore includes, for each finger contact area, determining a respective finger contact coordinate tuple based at least in part on: a respective location of a respective finger contact area, and the user contacts on the one or more touch-sensitive surfaces that are distinct from the touch-sensitive display. The method includes manipulating at least one of the one or more user interface objects in accordance with the respective finger contact coordinate tuples.

In accordance with some embodiments, an electronic device includes: a touch-sensitive surface display, one or more touch-sensitive surfaces that are distinct from the touch-sensitive display, one or more processors, memory, and one or more programs. The one or more programs are stored in the memory and configured to be executed by the one or more processors. The one or more programs include instructions for: displaying one or more user interface objects on the touch-sensitive display; and detecting one or more user contacts on the one or more touch-sensitive surfaces that are distinct from the touch-sensitive display. The one or more programs also include instructions for, while detecting the one or more user contacts on the one or more touch-sensitive surfaces that are distinct from the touch-sensitive display, detecting one or more finger contact areas at respective locations on the touch-sensitive display. The one or more programs furthermore include instructions for, for each finger contact area, determining a respective finger contact coordinate tuple based at least in part on: a respective location of a respective finger contact area, and the user contacts on the one or more touch-sensitive surfaces that are distinct from the touch-sensitive display. The one or more programs include instructions for manipulating at least one of the one or more user interface objects in accordance with the respective finger contact coordinate tuples.

In accordance with some embodiments, a computer readable storage medium has stored therein instructions which when executed by an electronic device with a touch-sensitive display and one or more touch-sensitive surfaces that are distinct from the touch-sensitive display, cause the device to: display one or more user interface objects on the touch-sensitive display; and detect one or more user contacts on the one or more touch-sensitive surfaces that are distinct from the touch-sensitive display. The instructions also cause the device to, while detecting the one or more user contacts on the one or more touch-sensitive surfaces that are distinct from the touch-sensitive display, detect one or more finger contact areas at respective locations on the touch-sensitive display. The instructions furthermore cause the device to, for each finger contact area, determine a respective finger contact coordinate tuple based at least in part on: a respective location of a respective finger contact area, and the user contacts on the one or more touch-sensitive surfaces that are distinct from the touch-sensitive display. The instructions cause the device to manipulate at least one of the one or more user interface objects in accordance with the respective finger contact coordinate tuples.

In accordance with some embodiments, a graphical user interface on an electronic device with a touch-sensitive display, one or more touch-sensitive surfaces that are distinct from the touch-sensitive display, a memory, and one or more processors to execute one or more programs stored in the memory includes one or more user interface objects on the touch-sensitive display. One or more user contacts are detected on the one or more touch-sensitive surfaces that are distinct from the touch-sensitive display. While detecting the one or more user contacts on the one or more touch-sensitive surfaces that are distinct from the touch-sensitive display, one or more finger contact areas are detected at respective locations on the touch-sensitive display. For each finger contact area, a respective finger contact coordinate tuple is determined based at least in part on: a respective location of a respective finger contact area, and the user contacts on the one or more touch-sensitive surfaces that are distinct from the touch-sensitive display. At least one of the one or more user interface objects is manipulated in accordance with the respective finger contact coordinate tuples.

In accordance with some embodiments, an electronic device includes: a touch-sensitive display and one or more touch-sensitive surfaces that are distinct from the touch-sensitive display; means for displaying one or more user interface objects on the touch-sensitive display; and means for detecting one or more user contacts on the one or more touch-sensitive surfaces that are distinct from the touch-sensitive display. The electronic device also includes, while detecting the one or more user contacts on the one or more touch-sensitive surfaces that are distinct from the touch-sensitive display, means for detecting one or more finger contact areas at respective locations on the touch-sensitive display; and means for determining a respective finger contact coordinate tuple for each finger contact area based at least in part on: a respective location of a respective finger contact area, and the user contacts on the one or more touch-sensitive surfaces that are distinct from the touch-sensitive display. The electronic device furthermore includes means for manipulating at least one of the one or more user interface objects in accordance with the respective finger contact coordinate tuples.

In accordance with some embodiments, an information processing apparatus for use in an electronic device with a touch-sensitive display and one or more touch-sensitive surfaces that are distinct from the touch-sensitive display includes: means for displaying one or more user interface objects on the touch-sensitive display; and means for detecting one or more user contacts on the one or more touch-sensitive surfaces that are distinct from the touch-sensitive display. The information processing apparatus also includes, while detecting the one or more user contacts on the one or more touch-sensitive surfaces that are distinct from the touch-sensitive display, means for detecting one or more finger contact areas at respective locations on the touch-sensitive display; and means for determining a respective finger contact coordinate tuple for each finger contact area based at least in part on: a respective location of a respective finger contact area, and the user contacts on the one or more touch-sensitive surfaces that are distinct from the touch-sensitive display. The information processing furthermore includes means for manipulating at least one of the one or more user interface objects in accordance with the respective finger contact coordinate tuples.

Thus, electronic devices with touch-sensitive displays and one or more touch-sensitive surfaces that are distinct from the touch-sensitive display are provided with more accurate and more efficient touch targeting methods and interfaces for determining finger contact coordinate tuples, thereby increasing the effectiveness, efficiency, and user satisfaction with such devices.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIGS. 1A and 1B are block diagrams illustrating portable multifunction devices with touch-sensitive displays and touch-sensitive surfaces in accordance with some embodiments.

FIG. 1C is a block diagram illustrating exemplary components for event handling in accordance with some embodiments.

FIG. 2 illustrates a portable multifunction device having a touch screen in accordance with some embodiments.

FIGS. 3A and 3B illustrate portable multifunction devices having touch-sensitive displays and touch-sensitive surfaces that are distinct from the touch-sensitive displays in accordance with some embodiments.

FIGS. 4A and 4B illustrate exemplary user interfaces for a menu of applications on a portable multifunction device in accordance with some embodiments.

FIGS. 5A-5F illustrate exemplary user interfaces for determining respective finger contact coordinate tuples in accordance with some embodiments.

FIGS. 6A-6C are flow diagrams illustrating a method of determining respective finger contact coordinate tuples in accordance with some embodiments.

### DESCRIPTION OF EMBODIMENTS

Many electronic devices have touch-sensitive displays for receiving touch inputs (e.g., gestures made with finger contacts). Such touch inputs are converted to coordinate tuples in a touch targeting process. In turn, the coordinate tuples are used to manipulate user interface objects displayed on the touch-sensitive displays. For efficient and effective use of touch-sensitive displays, it is important that the coordinate tuples determined by the device correspond to the locations on the touch sensitive display that a user perceives are being touched (and intends to touch), even if the locations perceived by the user do not correspond to the centers of actual touch locations. In the embodiments described below, an improved method for determining finger contact coordinate tuples is achieved by detecting contacts on touch-sensitive surfaces that are distinct from the touch-sensitive display, such as touch-sensitive surfaces on the sides and/or back of the device. Contact information from these touch-sensitive surfaces is used to select appropriate contact-area-to-coordinate-tuple conversion rules, thereby reducing or eliminating touch targeting errors. For example, if touch-sensitive surfaces on the back of the device detect that fingers from both the left and right hands of the user are touching the back of the device, then the inputs on the touch-sensitive display are probably coming from the user's left and right thumbs (e.g., the user is touch-typing with two thumbs). Thus, for the left touch input on the touch-sensitive display, the device applies a contact-area-to-coordinate-tuple conversion rule that is tailored to the left thumb. Similarly, for the right touch input on the touch-sensitive display, the device applies a contact-area-to-coordinate-tuple conversion rule that is tailored to the right thumb. This results in more accurate touch targeting as compared to using generic contact-area-to-coordinate-tuple conversion rules that do not take into account the identity of the finger contacts on the touch-sensitive display. Thus, in the embodiments described below, the contacts made on the touch-sensitive surfaces on the sides and/or back of the device are used to help determine the identities of the fingers on the touch-sensitive display, which in turn are used to apply contact-area-to-coordinate-tuple conversion rules that are tailored to the fingers on the touch-sensitive display.

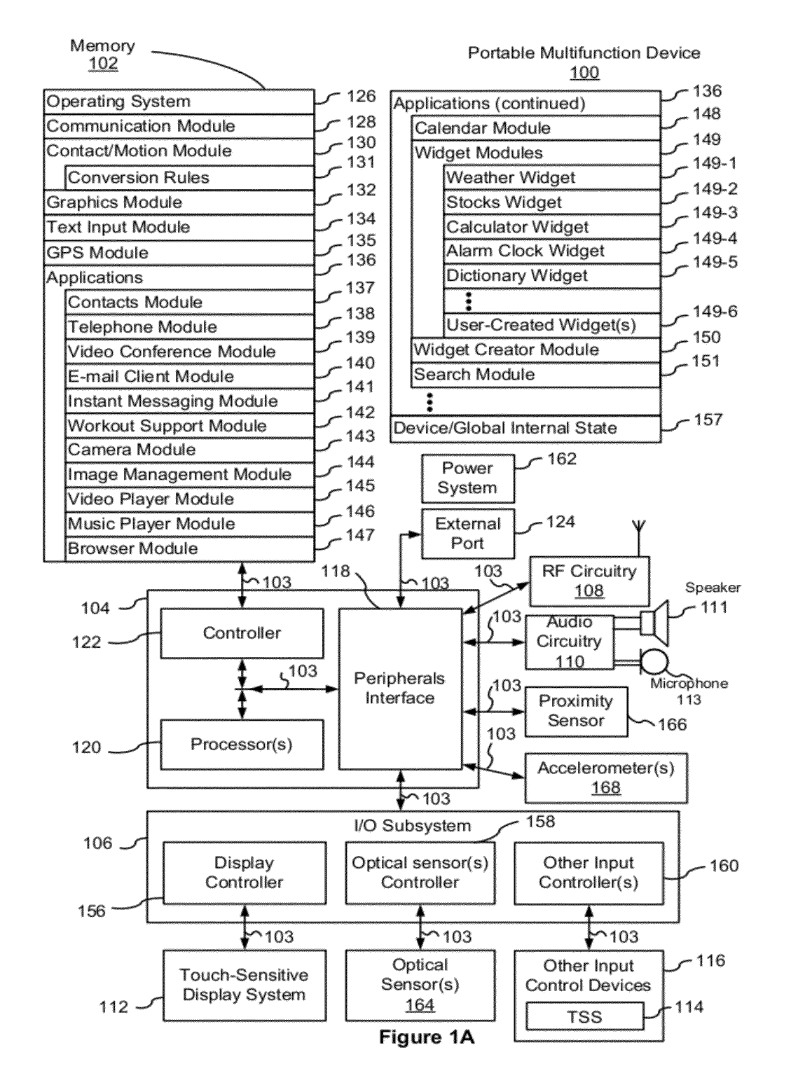

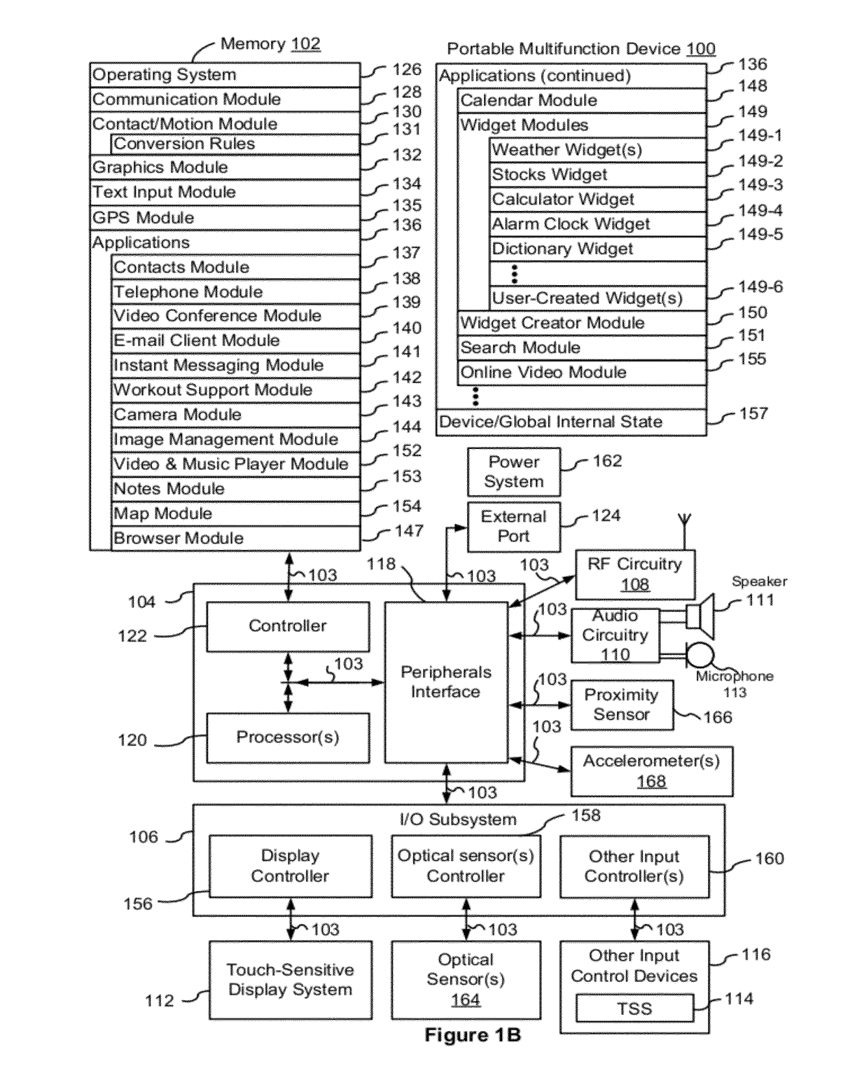

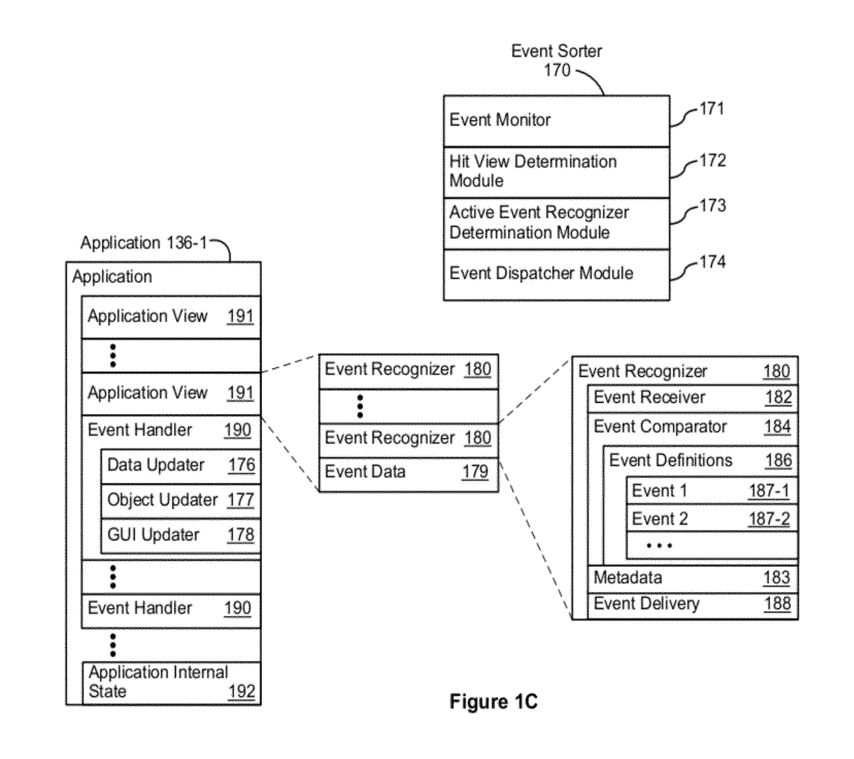

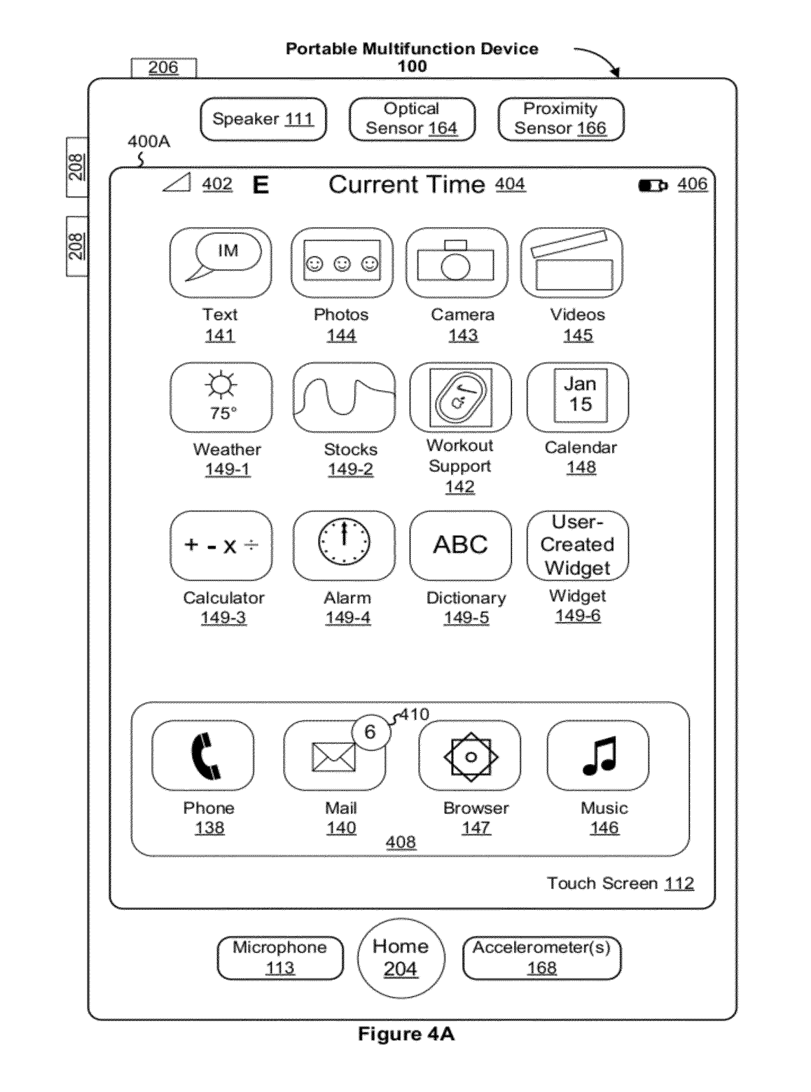

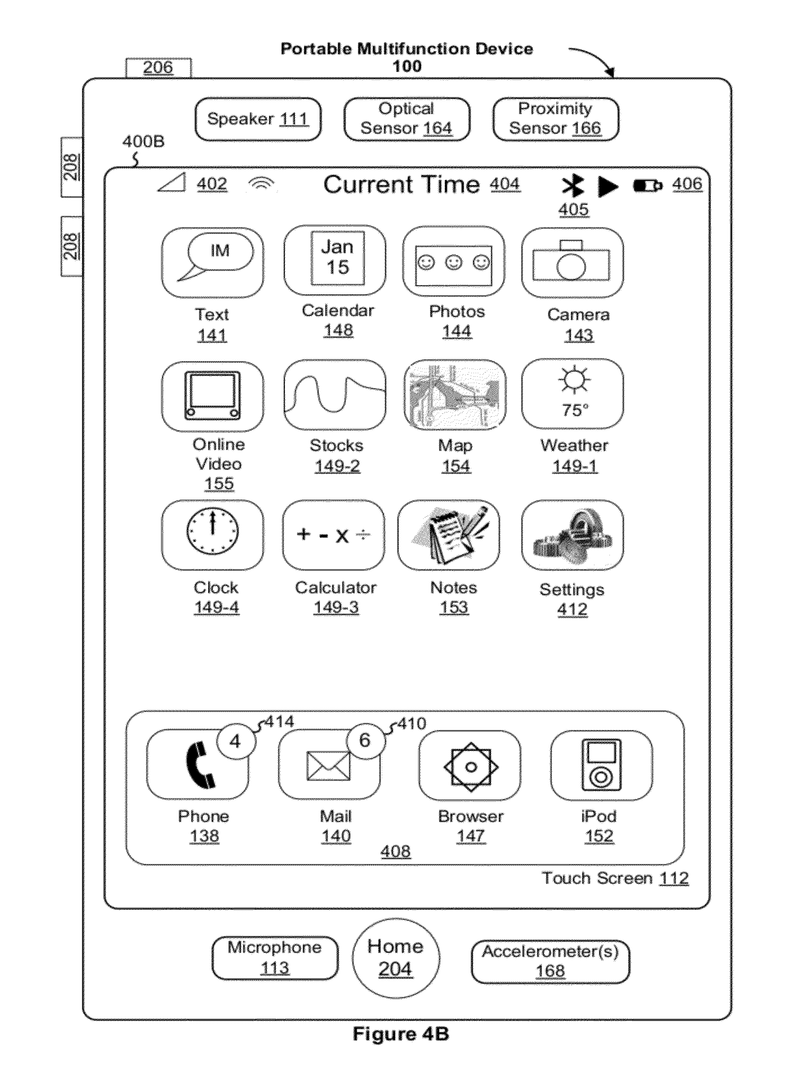

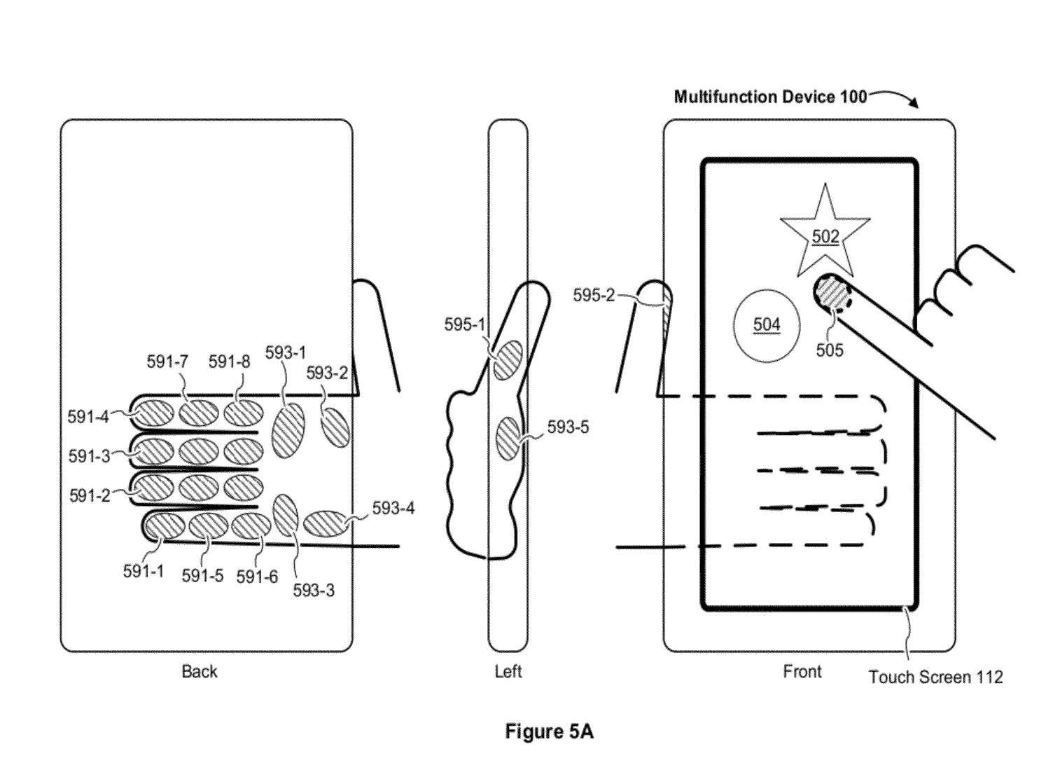

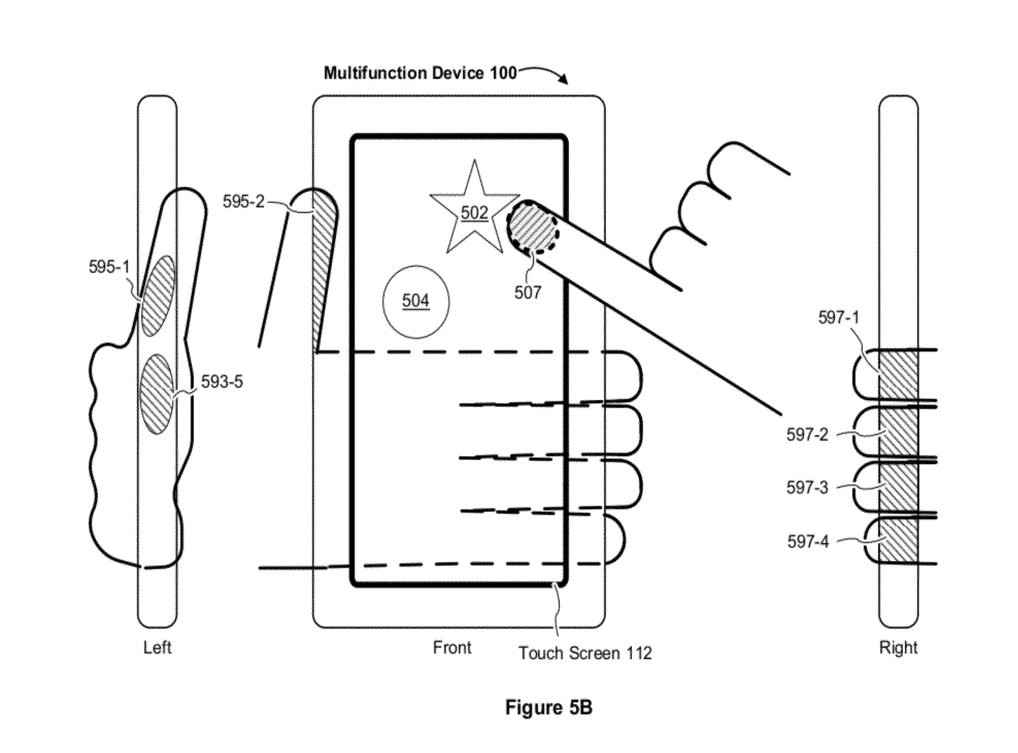

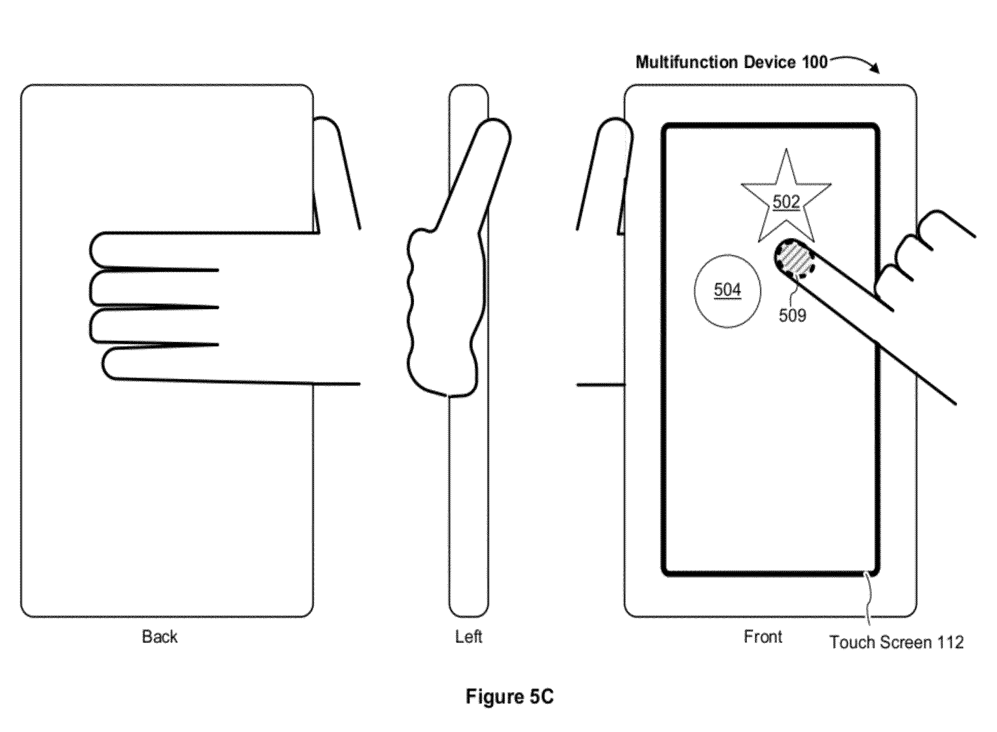

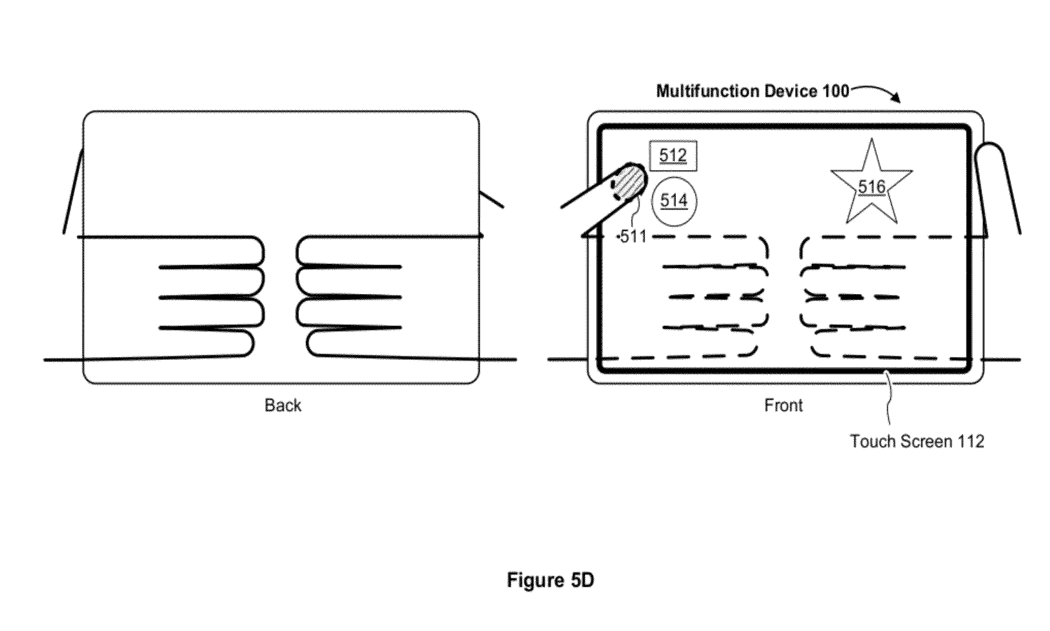

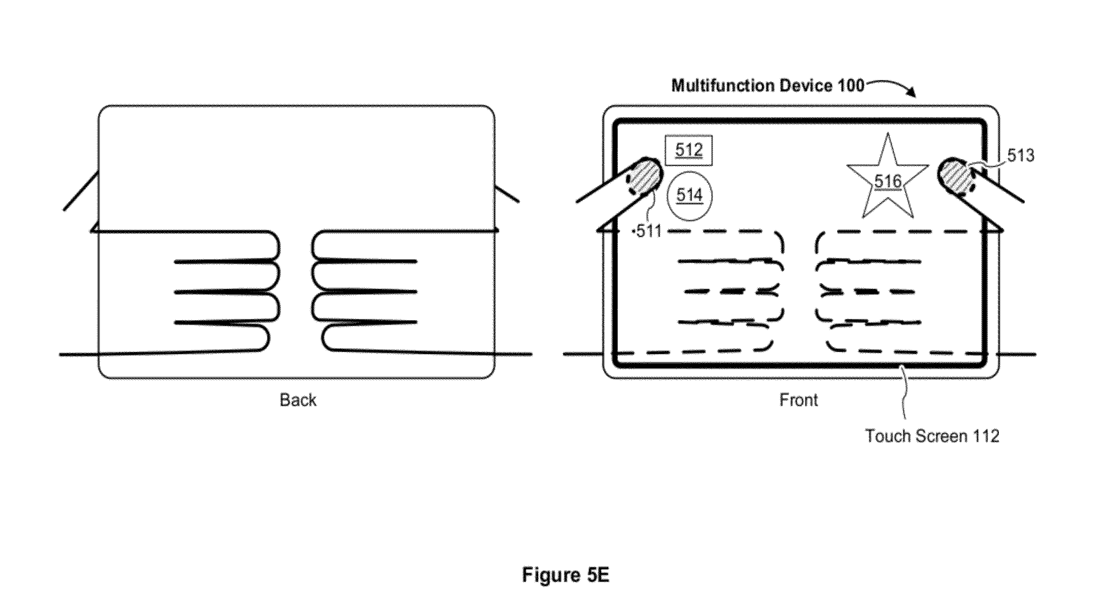

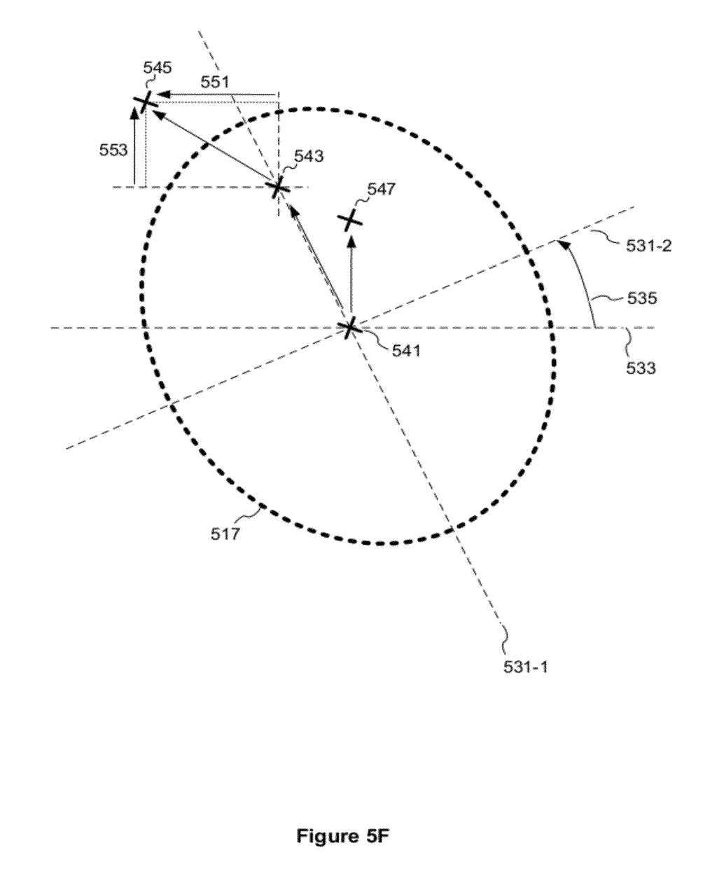

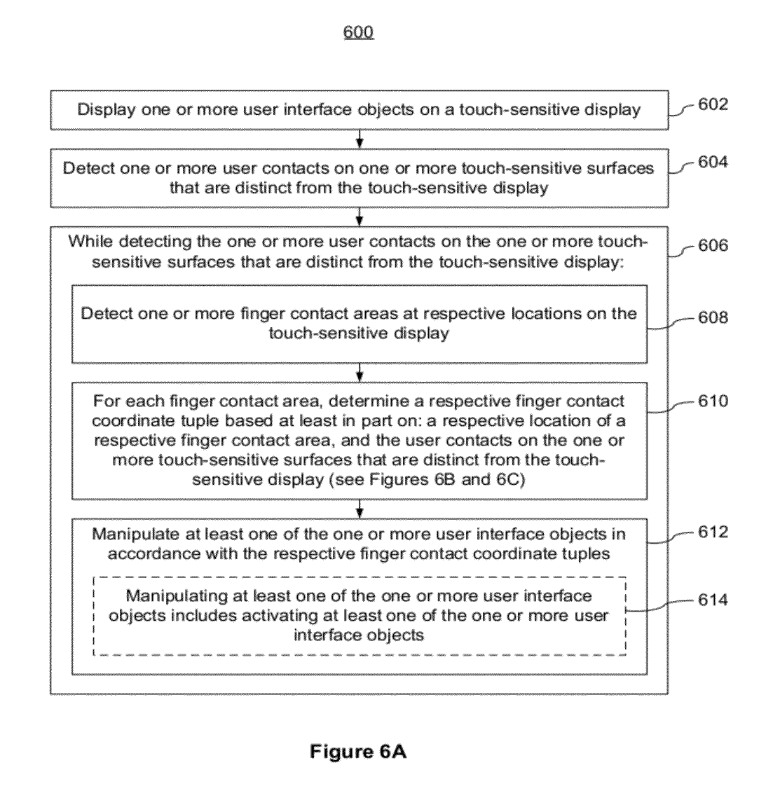

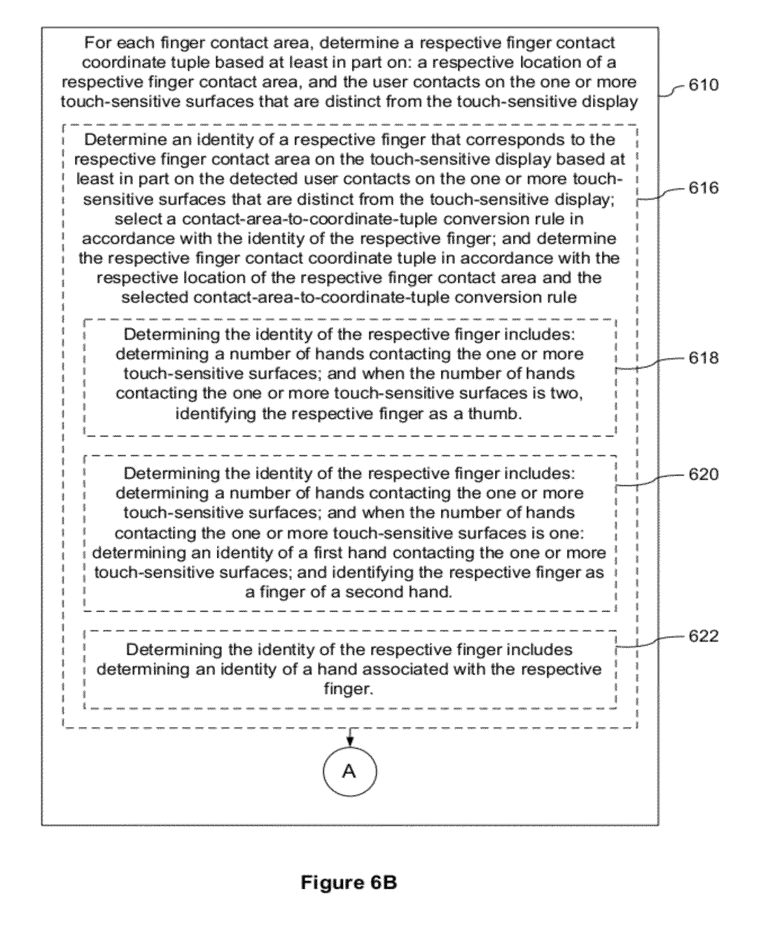

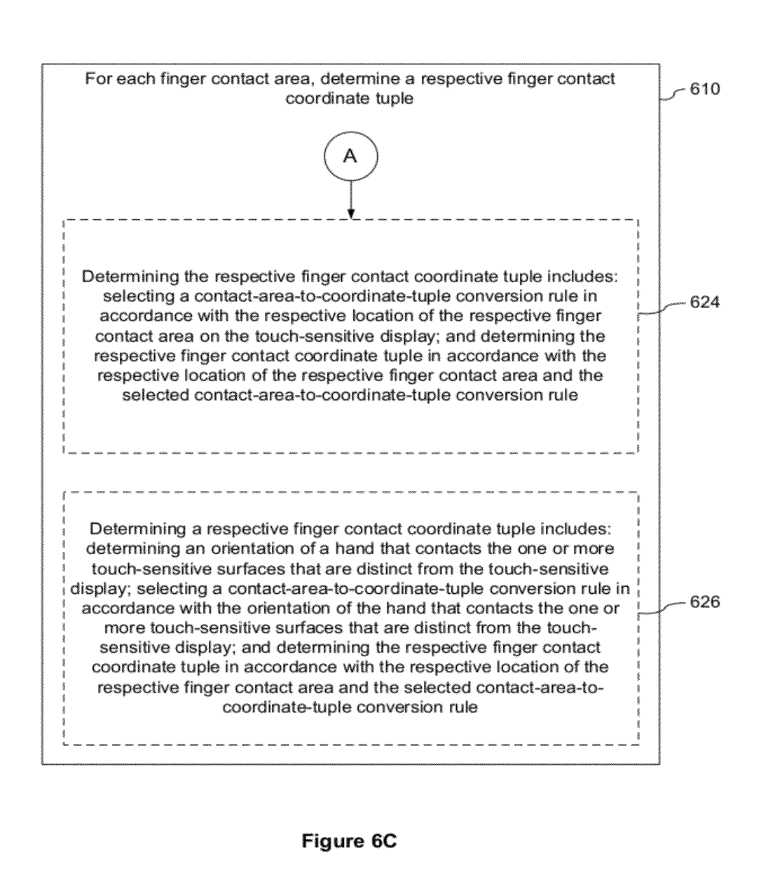

Below, FIGS. 1A-1C, 2, and 3A-3B provide a description of exemplary devices. FIGS. 4A-4B and 5A-5F illustrate exemplary user interfaces for determining finger contact coordinate tuples. FIGS. 6A-6C are flow diagrams illustrating a method of determining finger contact coordinate tuples. The user interfaces in FIGS. 5A-5F are used to illustrate the processes in FIGS. 6A-6C.

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if' may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

As used herein, the term “resolution” of a display refers to the number of pixels (also called “pixel counts” or “pixel resolution”) along each axis or in each dimension of the display. For example, a display may have a resolution of 320×480 pixels. Furthermore, as used herein, the term “resolution” of a multifunction device refers to the resolution of a display in the multifunction device. The term “resolution” does not imply any limitations on the size of each pixel or the spacing of pixels. For example, compared to a first display with a 1024×768-pixel resolution, a second display with a 320×480-pixel resolution has a lower resolution. However, it should be noted that the physical size of a display depends not only on the pixel resolution, but also on many other factors, including the pixel size and the spacing of pixels. Therefore, the first display may have the same, smaller, or larger physical size, compared to the second display.

As used herein, the term “video resolution” of a display refers to the density of pixels along each axis or in each dimension of the display. The video resolution is often measured in a dots-per-inch (DPI) unit, which counts the number of pixels that can be placed in a line within the span of one inch along a respective dimension of the display.

Embodiments of computing devices, user interfaces for such devices, and associated processes for using such devices are described. In some embodiments, the computing device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable devices, such as laptops or tablet computers with touch-sensitive displays and touch-sensitive surfaces that are distinct from the touch-sensitive displays may also be used. It should also be understood that, in some embodiments, the device is not a portable communications device, but is a desktop computer with a touch-sensitive display and one or more touch-sensitive surfaces that are distinct from the touch-sensitive display.

In the discussion that follows, a computing device is described that includes a touch-sensitive display and one or more touch-sensitive surfaces that are distinct from the touch-sensitive display. It should be understood, however, that the computing device may include one or more other physical user-interface devices, such as a physical keyboard, a mouse and/or a joystick.

The device supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that may be executed on the device may use at least one common physical user-interface device, such as the touch-sensitive display. One or more functions of the touch-sensitive display as well as corresponding information displayed on the device may be adjusted and/or varied from one application to the next and/or within a respective application. In this way, a common physical architecture (such as the touch-sensitive display) of the device may support the variety of applications with user interfaces that are intuitive and transparent to the user.

The user interfaces may include one or more soft keyboard embodiments. The soft keyboard embodiments may include standard (QWERTY) and/or non-standard configurations of symbols on the displayed icons of the keyboard, such as those described in U.S. patent applications Ser. No. 11/459,606, “Keyboards For Portable Electronic Devices,” filed Jul. 24, 2006, and Ser. No. 11/459,615, “Touch Screen Keyboards For Portable Electronic Devices,” filed Jul. 24, 2006, the contents of which are hereby incorporated by reference in their entireties. The keyboard embodiments may include a reduced number of icons (or soft keys) relative to the number of keys in existing physical keyboards, such as that for a typewriter. This may make it easier for users to select one or more icons in the keyboard, and thus, one or more corresponding symbols. The keyboard embodiments may be adaptive. For example, displayed icons may be modified in accordance with user actions, such as selecting one or more icons and/or one or more corresponding symbols. One or more applications on the device may utilize common and/or different keyboard embodiments. Thus, the keyboard embodiment used may be tailored to at least some of the applications. In some embodiments, one or more keyboard embodiments may be tailored to a respective user. For example, one or more keyboard embodiments may be tailored to a respective user based on a word usage history (lexicography, slang, individual usage) of the respective user. Some of the keyboard embodiments may be adjusted to reduce a probability of a user error when selecting one or more icons, and thus one or more symbols, when using the soft keyboard embodiments.

Attention is now directed toward embodiments of portable devices with touch-sensitive displays and one or more touch-sensitive surfaces that are distinct from the touch-sensitive displays. FIGS. 1A and 1B are block diagrams illustrating portable multifunction devices 100 with touch-sensitive displays 112 and one or more touch-sensitive surfaces 114 in accordance with some embodiments. Touch-sensitive display 112 is sometimes called a “touch screen” for convenience, and may also be known as or called a touch-sensitive display system. Device 100 may include memory 102 (which may include one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Other input or control devices 116 include one or more touch-sensitive surfaces (TSS) 114. Device 100 may include one or more optical sensors 164. These components may communicate over one or more communication buses or signal lines 103.

It should be appreciated that device 100 is only one example of a portable multifunction device, and that device 100 may have more or fewer components than shown, may combine two or more components, or may have a different configuration or arrangement of the components. The various components shown in FIGS. 1A and 1B may be implemented in hardware, software, or a combination of both hardware and software, including one or more signal processing and/or application specific integrated circuits.

Memory 102 may include high-speed random access memory and may also include non-volatile memory, such as one or more magnetic disk storage devices, flash memory devices, or other non-volatile solid-state memory devices. Access to memory 102 by other components of device 100, such as CPU 120 and the peripherals interface 118, may be controlled by memory controller 122.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 may be implemented on a single chip, such as chip 104. In some other embodiments, they may be implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

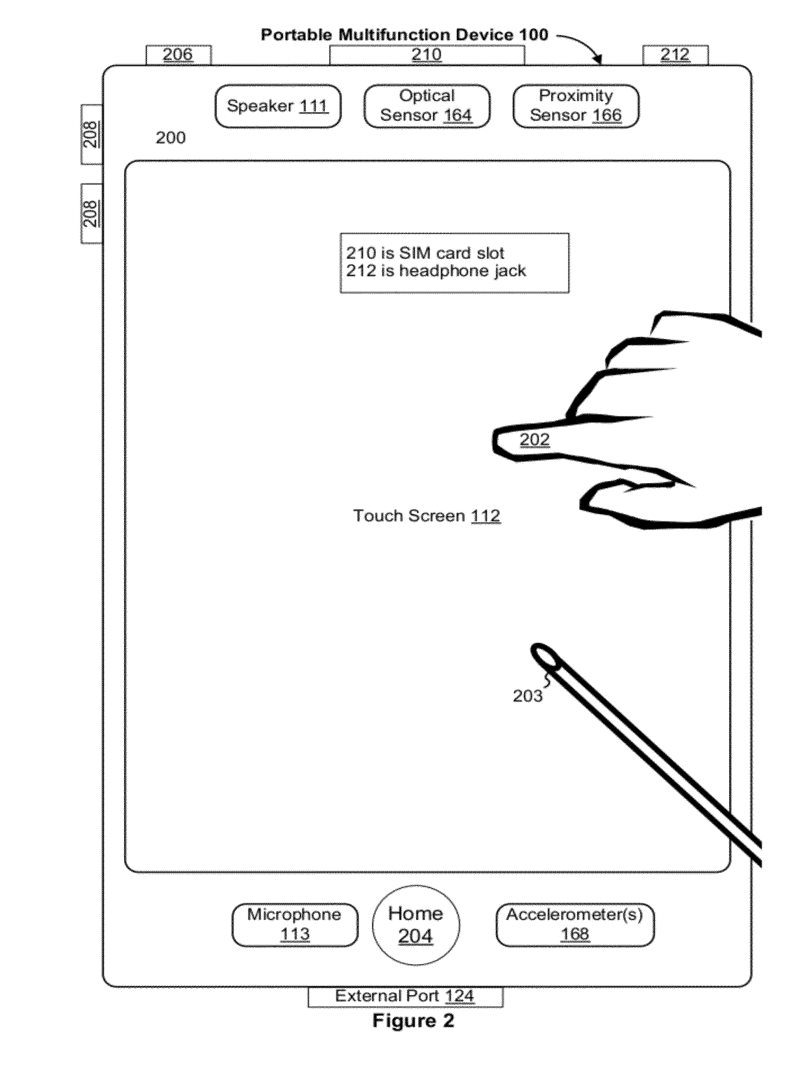

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data may be retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 may include display controller 156 and one or more input controllers 160 for other input or control devices. The one or more input controllers 160 receive/send electrical signals from/to other input or control devices 116. The other input control devices 116 include one or more touch-sensitive surfaces 114 that are distinct from the touch-sensitive display 112. The other input control devices 116 may also include physical buttons (e.g., push buttons, rocker buttons, etc.), dials, slider switches, joysticks, click wheels, and so forth. In some alternate embodiments, input controller(s) 160 may be coupled to any (or none) of the following: a keyboard, infrared port, USB port, and a pointer device such as a mouse. The one or more buttons (e.g., 208, FIG. 2) may include an up/down button for volume control of speaker 111 and/or microphone 113. The one or more buttons may include a push button (e.g., 206, FIG. 2). A quick press of the push button may disengage a lock of touch screen 112 or begin a process that uses gestures on the touch screen to unlock the device, as described in U.S. patent application Ser. No. 11/322,549, “Unlocking a Device by Performing Gestures on an Unlock Image,” filed Dec. 23, 2005, which is hereby incorporated by reference in its entirety. A longer press of the push button (e.g., 206) may turn power to device 100 on or off. The user may be able to customize a functionality of one or more of the buttons. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output may include graphics, text, icons, video, and any combination thereof (collectively termed “graphics”). In some embodiments, some or all of the visual output may correspond to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and converts the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 may use LCD (liquid crystal display) technology, LPD (light emitting polymer display) technology, or LED (light emitting diode) technology, although other display technologies may be used in other embodiments. Touch screen 112 and display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, Calif.

A touch-sensitive display in some embodiments of touch screen 112 may be analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from portable device 100, whereas touch sensitive touchpads do not provide visual output.

A touch-sensitive display in some embodiments of touch screen 112 may be as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 may have a video resolution in excess of 100 dpi. In some embodiments, the touch screen has a video resolution of approximately 160 dpi. The user may make contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

Device 100 includes one or more touch-sensitive surfaces 114 that are distinct from touch-sensitive display 112. The one or more touch-sensitive surfaces 114 include a sensor or a set of sensors that detects haptic and/or tactile contact by the user. Touch-sensitive surfaces 114 and input controller 160 (along with any associated modules and/or sets of instructions in memory 102) detect contacts on areas of the device outside the touch-sensitive display 112 (e.g., the sides and/or back of the device). This contact data is used by the device to determine how the device is being held (e.g., the location/orientation/manner of holding the device) and to help determine the identities of the finger contacts on the touch-sensitive display 112. In some embodiments, the one or more touch-sensitive surfaces 114 comprise one or more continuous touch-sensitive surfaces that are configured to detect a location of a respective contact on a respective continuous touch-sensitive surface. In some embodiments, the touch-sensitive surfaces 114 comprise a plurality of touch-sensitive sensors, and a respective touch-sensitive sensor is configured to detect a contact at a location that corresponds to the respective touch-sensitive sensor (e.g., a contact on the touch-sensitive sensor). The one or more touch-sensitive surfaces 114 typically do not display visual output. In some embodiments, some of the touch-sensitive surfaces 114 are physically or electrically connected to the touch-sensitive surface that is part of touch screen 112.

Touch-sensitive surfaces 114 may detect contact using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive surfaces 114.

In some embodiments, one or more touch-sensitive surfaces 114 may be as described in U.S. patent application Ser. No. 11/620,424, “Back-Side Interface For Hand-Held Devices,” filed Jan. 5, 2007, which is incorporated by reference herein in their entirety.

In some embodiments, device 100 may include a physical or virtual wheel (e.g., a click wheel) as input control device 116. A user may navigate among and interact with one or more graphical objects (e.g., icons) displayed in touch screen 112 by rotating the click wheel or by moving a point of contact with the click wheel (e.g., where the amount of movement of the point of contact is measured by its angular displacement with respect to a center point of the click wheel). The click wheel may also be used to select one or more of the displayed icons. For example, the user may press down on at least a portion of the click wheel or an associated button. User commands and navigation commands provided by the user via the click wheel may be processed by input controller 160 as well as one or more of the modules and/or sets of instructions in memory 102. For a virtual click wheel, the click wheel and click wheel controller may be part of touch screen 112 and display controller 156, respectively. For a virtual click wheel, the click wheel may be either an opaque or semitransparent object that appears and disappears on the touch screen display in response to user interaction with the device. In some embodiments, a virtual click wheel is displayed on the touch screen of a portable multifunction device and operated by user contact with the touch screen.

Device 100 also includes power system 162 for powering the various components. Power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 may also include one or more optical sensors 164. FIGS. 1A and 1B show an optical sensor coupled to optical sensor controller 158 in I/O subsystem 106. Optical sensor 164 may include charge-coupled device (CCD) or complementary metal-oxide semiconductor (CMOS) phototransistors. Optical sensor 164 receives light from the environment, projected through one or more lens, and converts the light to data representing an image. In conjunction with imaging module 143 (also called a camera module), optical sensor 164 may capture still images or video. In some embodiments, an optical sensor is located on the back of device 100, opposite touch screen display 112 on the front of the device, so that the touch screen display may be used as a viewfinder for still and/or video image acquisition. In some embodiments, an optical sensor is located on the front of the device so that the user's image may be obtained for videoconferencing while the user views the other video conference participants on the touch screen display. In some embodiments, the position of optical sensor 164 can be changed by the user (e.g., by rotating the lens and the sensor in the device housing) so that a single optical sensor 164 may be used along with the touch screen display for both video conferencing and still and/or video image acquisition.

Device 100 may also include one or more proximity sensors 166. FIGS. 1A and 1B show proximity sensor 166 coupled to peripherals interface 118. Alternately, proximity sensor 166 may be coupled to input controller 160 in I/O subsystem 106. Proximity sensor 166 may perform as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 may also include one or more accelerometers 168. FIGS. 1A and 1B show accelerometer 168 coupled to peripherals interface 118. Alternately, accelerometer 168 may be coupled to an input controller 160 in I/O subsystem 106. Accelerometer 168 may perform as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. In some embodiments, contact/motion module 130 includes a plurality of contact-area-to-coordinate-tuple conversion rules 131, which are used to convert contact area information to respective contact coordinate tuples. In some embodiments, a respective contact-area-to-coordinate-tuple conversion rule 131 comprises a respective vector that is configured to offset a respective coordinate tuple. In some embodiments, the magnitude of the vector is predefined (e.g., in pixels or in distance on touch screen 112). In some embodiments, the magnitude of the vector is determined in accordance with a size of a contact (e.g., based on the major axis length of the contact and/or the surface area of the contact). In some embodiments, the direction of the vector is predefined. In some embodiments, the direction of the vector is determined in accordance with one or more contacts on one or more touch-sensitive surfaces 114.

In some embodiments, contact-area-to-coordinate-tuple conversion rules 131 include the following, or a subset or a superset thereof: a finger-of-a-right-hand conversion rule; and a finger-of-a-left-hand conversion rule. In some embodiments, contact-area-to-coordinate-tuple conversion rules 131 include the following, or a subset or a superset thereof: a thumb-of-a-right-hand conversion rule; a thumb-of-a-left-hand conversion rule; a non-thumb-finger-of-a-right-hand conversion rule; and a non-thumb-finger-of-a-left-hand conversion rule. In some embodiments, contact-area-to-coordinate-tuple conversion rules 131 include the following, or a subset or a superset thereof: a thumb conversion rule; an index-finger conversion rule; a middle-finger conversion rule; a fourth-finger conversion rule; and a little-finger conversion rule, and each of these rules may be tailored to a respective hand. In some embodiments, contact-area-to-coordinate-tuple conversion rules 131 include the following, or a subset or a superset thereof: a held-by-the-upper-part conversion rule; a held-by-the-middle-part conversion rule; and a held-by-the-lower-part conversion rule. In some embodiments, contact-area-to-coordinate-tuple conversion rules 131 include the following, or a subset or a superset thereof: a contact-on-the-upper-part conversion rule; a contact-on-the-middle-part conversion rule; and a contact-on-the-lower-part conversion rule. In some embodiments, two or more contact-area-to-coordinate-tuple conversion rules are combined. For example, a thumb-of-a-left-hand conversion rule may comprise a combination of a thumb conversion rule and a finger-of-a-left-hand conversion rule. As another example, an index-finger-of-a-left-hand-contacting-lower-part-of-the-device-held-by-the-upper-part conversion rule may comprise a combination of an index-finger conversion rule; a finger-of-a-left-hand conversion rule; a contact-on-the-lower-part conversion rule; and a held-by-the-upper-part conversion rule. In some embodiments, contact-area-to-coordinate-tuple conversion rules 131 include any combination of the conversion rules described above, or a subset or a superset thereof.

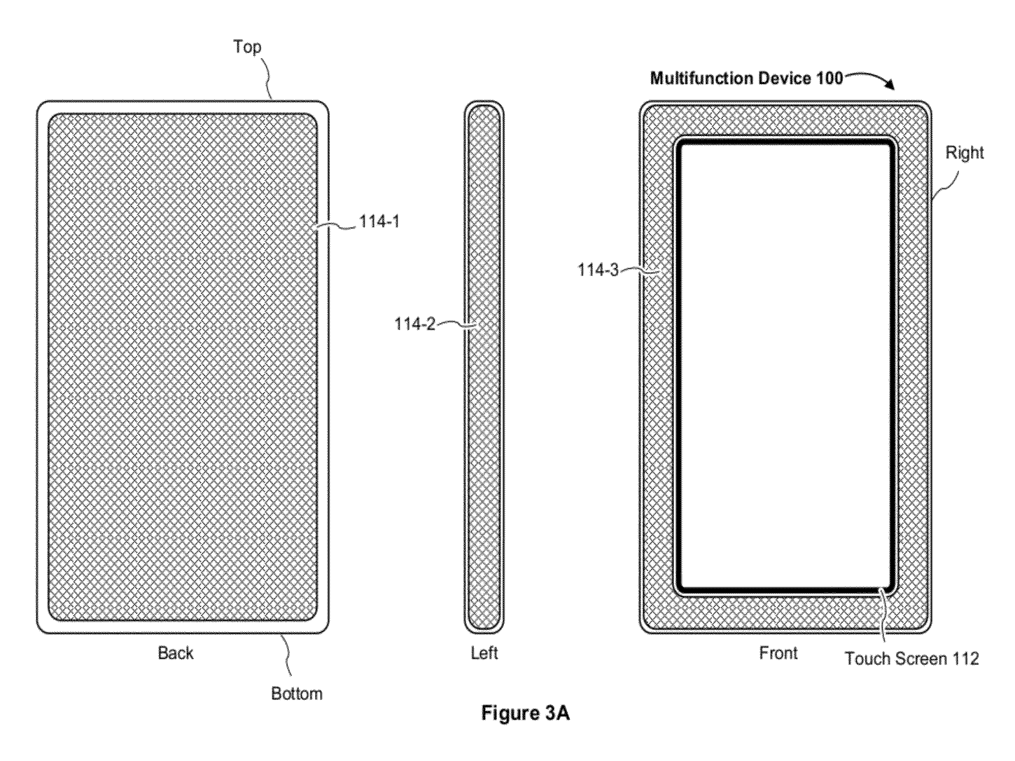

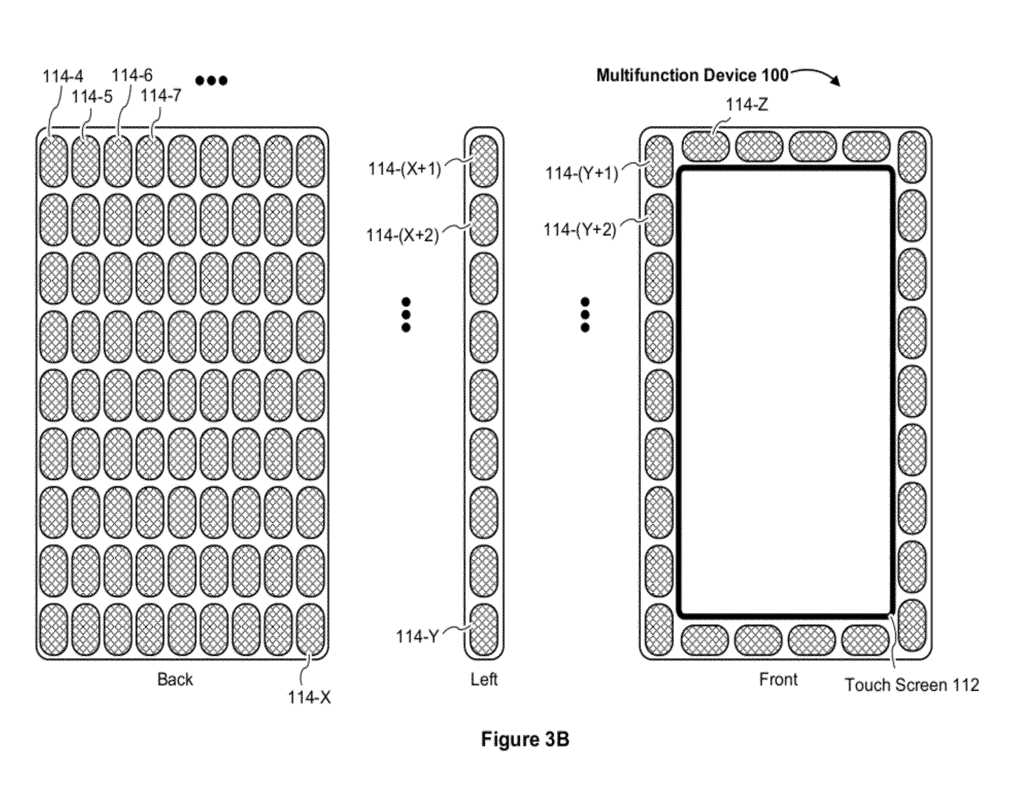

Furthermore, in some embodiments memory 102 stores device/global internal state 157, as shown in FIGS. 1A, 1B and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 may detect contact with touch screen 112 (in conjunction with display controller 156), touch sensitive surfaces 114 (in conjunction with input controller 160), and other touch sensitive devices (e.g., a touchpad or physical click wheel). Contact/motion module 130 includes various software components for performing various operations related to detection of contact, such as determining if contact has occurred (e.g., detecting a finger-down event), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). As noted above, a finger contact on touch screen 112 includes a contact area. In some embodiments, contact/motion module 130 converts contact areas to respective contact coordinate tuples using contact-area-to-coordinate-tuple conversion rules 131. In some embodiments, contact/motion module 130 and controller 160 detects contact on a click wheel.

Contact/motion module 130 may detect a gesture input by a user. Different gestures on the touch-sensitive display have different contact patterns. Thus, a gesture may be detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive display includes detecting a finger-down event followed by detecting one or more finger-dragging events, and subsequently followed by detecting a finger-up (lift off) event.

Graphics module 132 includes various known software components for rendering and displaying graphics on touch screen 112 or other display, including components for changing the intensity of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic may be assigned a corresponding code. Graphics module 132 receives, from applications etc., one or more codes specifying graphics to be displayed along with, if necessary, coordinate data and other graphic property data, and then generates screen image data to output to display controller 156.

Text input module 134, which may be a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 may include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module 145;
music player module 146;
browser module 147;
calendar module 148;
widget modules 149, which may include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module 145 and music player module 146;
notes module 153;
map module 154; and/or
online video module 155.

Examples of other applications 136 that may be stored in memory 102 include other word processing applications, other image editing applications, drawing applications, presentation applications, JAVA-enabled applications, encryption, digital rights management, voice recognition, and voice replication.

In conjunction with touch screen 112, touch-sensitive surface 114, display controller 156, input controller 160, contact module 130, graphics module 132, and text input module 134, contacts module 137 may be used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch screen 112, touch-sensitive surface 114, display controller 156, input controller 160, contact module 130, graphics module 132, and text input module 134, telephone module 138 may be used to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication may use any of a plurality of communications standards, protocols and technologies.

In conjunction with RF circuitry 108, audio circuitry 110, speaker 111, microphone 113, touch screen 112, touch-sensitive surface 114, display controller 156, input controller 160, optical sensor 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch screen 112, touch-sensitive surface 114, display controller 156, input controller 160, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, touch-sensitive surface 114, display controller 156, input controller 160, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages may include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, touch-sensitive surface 114, display controller 156, input controller 160, contact module 130, graphics module 132, text input module 134, GPS module 135, map module 154, and music player module 146, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store and transmit workout data.

In conjunction with touch screen 112, touch-sensitive surface 114, display controller 156, input controller 160, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, touch-sensitive surface 114, display controller 156, input controller 160, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with touch screen 112, touch-sensitive surface 114, display controller 156, input controller 160, contact module 130, graphics module 132, audio circuitry 110, and speaker 111, video player module 145 includes executable instructions to display, present or otherwise play back videos (e.g., on touch screen 112 or on an external, connected display via external port 124).

In conjunction with touch screen 112, touch-sensitive surface 114, display system controller 156, input controller 160, contact module 130, graphics module 132, audio circuitry 110, speaker 111, RF circuitry 108, and browser module 147, music player module 146 includes executable instructions that allow the user to download and play back recorded music and other sound files stored in one or more file formats, such as MP3 or AAC files. In some embodiments, device 100 may include the functionality of an MP3 player, such as an iPod (trademark of Apple Inc.).

In conjunction with RF circuitry 108, touch screen 112, touch-sensitive surface 114, display system controller 156, input controller 160, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, touch-sensitive surface 114, display system controller 156, input controller 160, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch screen 112, touch-sensitive surface 114, display system controller 156, input controller 160, contact module 130, graphics module 132, text input module 134, and browser module 147, widget modules 149 are mini-applications that may be downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, touch-sensitive surface 114, display system controller 156, input controller 160, contact module 130, graphics module 132, text input module 134, and browser module 147, the widget creator module 150 may be used by a user to create widgets (e.g., turning a user-specified portion of a web page into a widget).

In conjunction with touch screen 112, touch-sensitive surface 114, display system controller 156, input controller 160, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, touch-sensitive surface 114, display controller 156, input controller 160, contact module 130, graphics module 132, and text input module 134, notes module 153 includes executable instructions to create and manage notes, to do lists, and the like in accordance with user instructions.

In conjunction with RF circuitry 108, touch screen 112, touch-sensitive surface 114, display system controller 156, input controller 160, contact module 130, graphics module 132, text input module 134, GPS module 135, and browser module 147, map module 154 may be used to receive, display, modify, and store maps and data associated with maps (e.g., driving directions; data on stores and other points of interest at or near a particular location; and other location-based data) in accordance with user instructions.

In conjunction with touch screen 112, touch-sensitive surface 114, display system controller 156, input controller 160, contact module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the content of which is hereby incorporated by reference in its entirety.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise re-arranged in various embodiments. For example, video player module 145 may be combined with music player module 146 into a single module (e.g., video and music player module 152, FIG. 1B). In some embodiments, memory 102 may store a subset of the modules and data structures identified above. Furthermore, memory 102 may store additional modules and data structures not described above.

In some embodiments, device 100 is a device where operation of a predefined set of functions on the device is performed exclusively through a touch screen. By using a touch screen as the primary input control device for operation of device 100, the number of physical input control devices (such as push buttons, dials, and the like) on device 100 may be reduced.

The predefined set of functions that may be performed exclusively through a touch screen include navigation between user interfaces.

In some embodiments, device 100 includes a physical push button or other physical input control device that may be referred to as a “menu button.” In some embodiments, the menu button, when touched by the user, navigates device 100 to a main, home, or root menu from any user interface that may be displayed on device 100.

FIG. 1C is a block diagram illustrating exemplary components for event handling in accordance with some embodiments. In some embodiments, memory 102 (in FIGS. 1A and 1B) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch sensitive display 112 when the application is active or executing. In some embodiments, device/global internal state 157 is used by event sorter 170 to determine which application(s) is(are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 and touch-sensitive surface 114.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected may correspond to programmatic levels within a programmatic or view hierarchy of the application. For example, the lowest level view in which a touch is detected may be called the hit view, and the set of events that are recognized as proper inputs may be determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (i.e., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 may utilize or call data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which may include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch the event information may also include speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers may interact with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module 145. In some embodiments, object updater 177 creates and updates objects used in application 136-1. For example, object updater 176 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens, e.g., coordinating mouse movement and mouse button presses with or without single or multiple keyboard presses or holds, user movements taps, drags, scrolls, etc., on touch-pads, pen stylus inputs, movement of the device, oral instructions, detected eye movements, biometric inputs, and/or any combination thereof, which may be utilized as inputs corresponding to sub-events which define an event to be recognized.

FIG. 2 illustrates a portable multifunction device 100 having a touch screen 112 in accordance with some embodiments. The touch screen may display one or more graphics within user interface (UI) 200. In this embodiment, as well as others described below, a user may select one or more of the graphics by making contact or touching the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the contact may include a gesture, such as one or more taps, one or more swipes (from left to right, right to left, upward and/or downward) and/or a rolling of a finger (from right to left, left to right, upward and/or downward) that has made contact with device 100. In some embodiments, inadvertent contact with a graphic may not select the graphic. For example, a swipe gesture that sweeps over an application icon may not select the corresponding application when the gesture corresponding to selection is a tap.

Device 100 may also include one or more physical buttons, such as “home” or menu button 204. As described previously, menu button 204 may be used to navigate to any application 136 in a set of applications that may be executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also may accept verbal input for activation or deactivation of some functions through microphone 113.

FIGS. 3A and 3B illustrate portable multifunction devices having touch-sensitive displays and touch-sensitive surfaces 114 that are distinct from the touch-sensitive displays in accordance with some embodiments.

FIG. 3A depicts that portable multifunction device 100 has touch-sensitive surfaces on its back (e.g., 114-1), sides (e.g., left 114-2, right (not shown), top (not shown), and bottom (not shown)), and front bezel (e.g., 114-3). In some embodiments, touch-sensitive surfaces 114 are integrated (e.g., touch-sensitive surfaces 114 on its back, sides, and front bezel are an extension of a single touch-sensitive surface). In some embodiments, touch-sensitive surfaces 114 include distinct touch-sensitive surfaces on different areas (e.g., back, sides, and front bezel) of device 100. In some embodiments, device 100 includes a subset of, but not all, touch-sensitive surfaces depicted in FIG. 3A. For example, device 100 may include touch-sensitive surfaces on its back and front bezel, but not on its sides. Alternatively, device 100 may include one or more touch-sensitive surfaces on its front bezel and sides, but not on its back; on its sides and back, but not on its front bezel; on its front bezel only, but not on its sides or back; on its sides only, but not on its front bezel or back; or on its back only, but not on its front bezel and sides. In some embodiments, device 100 includes touch-sensitive surfaces on one of: the back side, the four sides, and the front bezel of device 100. In some embodiments, the device has distinct touch-sensitive surfaces for four sides (top, bottom, left, and right). In some embodiments, the device may have a single continuous touch-sensitive surface for four sides. In some embodiments, the device has distinct touch-sensitive surfaces for two sides (e.g., left and right).

FIG. 3B depicts that portable multifunction device 100 has a plurality of touch-sensitive surfaces 114 on its back (e.g., 114-4 through 114-X), sides (e.g., 114-(X+1) through 114-Y and additional touch-sensitive surfaces on right, top, and bottom sides (not shown)), and front bezel (e.g., 114-(Y+1) through 114-Z). The plurality of touch-sensitive surfaces 114 may be arranged in a pattern (e.g., a grid pattern as depicted in FIG. 3B, a honeycomb pattern, a spiral pattern, etc.). In some embodiments, a combination of two or more patterns is used (e.g., a respective pattern is used for a respective area of device 100).

In some embodiments, the plurality of touch-sensitive surfaces 114 is not uniformly distributed. In some embodiments, the plurality of touch-sensitive surfaces 114 on the back of device 100 is more densely positioned along the edges than near the center, or vice versa (not shown). In some embodiments, the plurality of touch-sensitive surfaces 114 on the back of device 100 is positioned along the edges (e.g., touch-sensitive surfaces are not located near the center of the back side of device 100 (not shown)).

In some embodiments, the plurality of touch-sensitive surfaces 114 on respective sides (e.g., 114-2 on the left side) of device 100 is not uniformly distributed. In some embodiments, the plurality of touch-sensitive surfaces 114 on respective sides (e.g., left and/or right side) of device 100 is more densely located near the middle than toward the top and bottom of device 100. In some embodiments, the plurality of touch-sensitive surfaces 114 on respective sides (e.g., left and/or right side) of device 100 is located near the middle and not toward the top and bottom of device 100.

In some embodiments, the plurality of touch-sensitive surfaces 114 on the front bezel of device 100 is not uniformly distributed. In some embodiments, the plurality of touch-sensitive surfaces 114 on the front bezel of device 100 is more densely located near the sides than near the top and bottom of device 100. In some embodiments, the plurality of touch-sensitive surfaces 114 on the front bezel is located along the sides and not along the top and bottom of device 100.

Attention is now directed towards embodiments of user interfaces (“UI”) that may be implemented on portable multifunction device 100.

FIGS. 4A and 4B illustrate exemplary user interfaces for a menu of applications on portable multifunction device 100 in accordance with some embodiments. In some embodiments, user interface 400A includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Phone 138, which may include an indicator 414 of the number of missed calls or voicemail messages;
   E-mail client 140, which may include an indicator 410 of the number of unread e-mails;
   Browser 147; and
   Music player 146; and
Icons for other applications, such as:
   IM 141;
   Image management 144;
   Camera 143;
   Video player 145;
   Weather 149-1;
   Stocks 149-2;
   Workout support 142;
   Calendar 148;
   Calculator 149-3;
   Alarm clock 149-4;
   Dictionary 149-5; and
   User-created widget 149-6.

In some embodiments, user interface 400B includes the following elements, or a subset or superset thereof:
402, 404, 405, 406, 141, 148, 144, 143, 149-3, 149-2, 149-1, 149-4, 410, 414, 138, 140, and 147, as described above;
Map 154;
Notes 153;
Settings 412, which provides access to settings for device 100 and its various applications 136, as described further below;
Video and music player module 152, also referred to as iPod (trademark of Apple Inc.) module 152; and
Online video module 155, also referred to as YouTube (trademark of Google Inc.) module 155.

Attention is now directed towards embodiments of user interfaces (“UI”) and associated processes that may be implemented on a multifunction device with a touch-sensitive display and one or more touch-sensitive surfaces that are distinct from the touch-sensitive display, such as portable multifunction device 100.

FIGS. 5A-5F illustrate exemplary user interfaces for determining respective finger contact coordinate tuples in accordance with some embodiments. The user interfaces in these figures are used to illustrate the processes described below, including the processes in FIGS. 6A-6C.

In FIGS. 5A-5F, the size of contacts (e.g., finger contacts and/or palm contacts) or the distance to user interface objects may be exaggerated for illustrative purposes. No depiction in the figures bearing on sizes or distances to user interface objects should be taken as a requirement or limitation for the purpose of understanding sizes and scale associated with the methods and devices disclosed herein.

FIG. 5A depicts that device 100 displays a plurality of user interface objects 502 and 504 on touch screen 112. Device 100 is held by a left hand of a user. As illustrated, when holding device 100 with the left hand, the user contacts the back (e.g., contacts 591 made with fingers and contacts 593 made with a palm), left (e.g., contact 593-5 made with a part of the palm and/or contact 595-1 made with a part of the thumb), and front sides (e.g., contact 595-2 made with a part of the thumb) of device 100. The user contacts on device 100 are detected by one or more touch-sensitive surfaces (e.g., 114, FIGS. 1A-1B and 3A-3B). In addition, finger contact 505 is detected on touch screen 112.

Device 100 determines finger contact coordinate tuples based at least in part on the respective user contacts on the one or more touch-sensitive surfaces 114. In some embodiments, based on the detected contacts, device 100 selects a respective contact-area-to-coordinate-tuple conversion rule to determine a respective finger contact coordinate tuple. For example, when conversion rules 131 include a finger-of-a-right-hand conversion rule and a left hand is used to hold device 100, device 100 determines that device 100 is held by a left hand (e.g., based on contacts on the back, left, and front sides), therefore finger contact 505 is made with a finger of a right hand, and device 100 selects the finger-of-a-right-hand conversion rule. In some embodiments, device 100 may determine that device 100 is held by a left hand based on contacts on one or more of: the back, left, and front sides of device 100 (e.g., device 100 may determine that device 100 is held by a left hand solely by a pattern of contacts on the back side or the left side of device 100).

As another example, when conversion rules 131 include an index-finger-of-a-right-hand conversion rule and a left hand is used to hold device 100, device 100 may additionally determine that finger contact 505 is made with an index finger of a right hand based on an area of finger contact 505 (e.g., size and/or ellipticity of the contact area) or by default, and select the index-finger-of-a-right-hand conversion rule. Similarly, when conversion rules 131 include other finger specific conversion rules, device 100 determines an identity of a finger that is used to make a contact, and selects a finger specific conversion rule that corresponds to the determined identity of the finger.

In some embodiments, for a respective contact on the one or more touch-sensitive surfaces 114, device 100 determines whether the respective contact is made with a finger or a palm (e.g., based on the area of the respective contact and/or a location of the respective contact relative to respective locations of other contacts).

In FIG. 5B, device 100 displays a plurality of user interface objects 502 and 504 on touch screen 112. Device 100 is held by a left hand of a user. As illustrated, when holding device 100 with the left hand, the user contacts the left (e.g., contact 593-5 made with a part of the palm and/or contact 595-1 made with a part of the thumb), front (e.g., contact 595-2 made with a part of the thumb), and right sides (e.g., contacts 597 made with non-thumb fingers) of device 100. In some embodiments, when holding device 100 with the left hand, the user also contacts the back side of device 100 (contacts not shown). The contacts on device 100 are detected by one or more touch-sensitive surfaces (e.g., 114, FIGS. 1A-1B and 3A-3B). In addition, finger contact 507 is detected on touch screen 112.

Device 100 determines finger contact coordinate tuples based at least in part on the respective user contacts on the one or more touch-sensitive surfaces 114. In some embodiments, based on the detected contacts, device 100 selects a respective contact-area-to-coordinate tuple conversion rule to determine a respective finger contact coordinate tuple. For example, when conversion rules 131 include a finger-of-a-right-hand conversion rule and a left hand is used to hold device 100, device 100 determines that device 100 is held by a left hand (e.g., based on contacts on the front, left, and right sides), therefore finger contact 507 is made with a finger of a right hand, and device 100 selects a finger-of-a-right-hand conversion rule. When contacts are detected on both left and right sides of device 100, device 100 determines whether device 100 is held by a left hand or a right hand based on one or more of: the number of contacts on the left side and the number of contacts on the right side (e.g., as depicted, when held by a right hand, the right side has four contacts, and the left side has two or less contacts); whether a finger contact on the front side is on the left side or the right side of device 100; and a pattern of contacts on the back side of device 100 (e.g., location of contacts that correspond to a palm and/or location of contacts that correspond to fingers). As another example, when conversion rules 131 include an index-finger-of-a-right-hand conversion rule and a left hand is used to hold device 100, device 100 may additionally determine that finger contact 507 is made with an index finger of a right hand based on an area of finger contact 507 (e.g., size or ellipticity of the contact area) or by default, and select the index-finger-of-a-right-hand conversion rule. Similarly, when conversion rules 131 include other finger specific conversion rules, device 100 determines an identity of a finger that is used to make a contact, and selects a finger specific conversion rule that corresponds to the determined identity of the finger.

FIG. 5C depicts that device 100 displays a plurality of user interface objects 502 and 504 on touch screen 112. In FIG. 5C, device 100 is held by a left hand near the top half of device 100, as compared to device 100 held near the bottom half of device 100 (e.g., FIG. 5A). User contacts on device 100 are detected by one or more touch-sensitive surfaces (e.g., 114, FIGS. 1A-1B and 3A-3B). In addition, finger contact 509 is detected on touch screen 112.

In some embodiments, device 100 determines finger contact coordinate tuples based at least in part on the respective locations of the user contacts on the one or more touch-sensitive surfaces. In some embodiments, based on the respective locations of detected contacts, device 100 selects a contact-area-to-coordinate tuple conversion rule to determine a respective finger contact coordinate tuple. For example, when conversion rules 131 include a held-by-the-upper-part conversion rule, device 100 may determine that device 100 is held by the top half of device 100, and select the held-by-the-upper-part conversion rule. Analogously, when conversion rules 131 include a held-by-the-lower-part conversion rule, device 100 may determine that device 100 is held by the bottom half of device 100, and select the held-by-the-lower-part conversion rule. In some embodiments, conversion rules 131 include held-by-the-middle-part conversion rule for use when device 100 is held by a hand positioned near the middle of device 100.

Although FIGS. 5A-5C depict device 100 held by a left hand of a user, device 100 can be held by a right hand of a user. Contacts on the one or more touch-sensitive surfaces 114 when device 100 is held by a right hand are analogous to the contacts on the one or more touch-sensitive surfaces 114 when device 100 is held by a left hand. Therefore, detailed description of device 100 held by a right hand of a user is omitted for brevity.

FIGS. 5D-5E illustrate device 100 held by two hands in accordance with some embodiments.

FIG. 5D depicts that device 100 displays a plurality of user interface objects 512 through 516 on touch screen 112. In FIG. 5D, device 100 is held by both left and right hands. User contacts on device 100 are detected by one or more touch-sensitive surfaces (e.g., 114, FIGS. 1A-1B and 3A-3B). In addition, finger contact 511 is detected on touch screen 112.

Device 100 determines respective finger contact coordinate tuples based at least in part on the user contacts on the one or more touch-sensitive surfaces 114. In some embodiments, based on the detected contacts, device 100 selects a contact-area-to-coordinate tuple conversion rule to determine a respective finger contact coordinate tuple. For example, when conversion rules 131 include a thumb conversion rule, device 100 determines that finger contact 511 is made with a thumb, and selects the thumb conversion rule. Device 100 may determine that finger contact 511 is made with a thumb based on one or more of: the area of finger contact 511 (e.g., size and/or ellipticity of the contact area); the number of fingers detected on the one or more touch-sensitive surfaces (e.g., when eight fingers are detected on the back side of device 100, assume that a contact on touch screen 112 is made with a thumb); and whether two hands are used to hold device 100 (e.g., based on the distribution of contacts on the back and/or left and right sides of device 100).

In some embodiments, when device 100 determines that a finger contact is made with a thumb, device 100 determines whether the finger contact is made with a left thumb or a right thumb. For example, when device 100 determines that finger contact 511 is made with a thumb and finger contact 511 is detected on a left-half of touch screen 112, device 100 determines that finger contact 511 is made with a left thumb and selects a left-thumb conversion rule. Similarly, when finger contact 513 (FIG. 5E) is made with a thumb and finger contact 513 is detected on a right-half of touch screen 112, device 100 determines that finger contact 513 is made with a right thumb and selects a right-thumb conversion rule. Additionally, or alternatively, device 100 determines that finger contact 513 is made with a left thumb or a right thumb based on an angle of finger contact 513 (e.g., an angle of a major axis that corresponds to finger contact 513).

FIG. 5F illustrates an exemplary finger contact area 517 detected on touch screen 112. As illustrated, a finger contact (e.g., 517) typically has an elliptical (or oval) shape. An ellipse has a major axis (e.g., 531-1) and a minor axis (e.g., 531-2). In some cases, an angle between a predefined reference axis of display 112 (e.g., horizontal axis 533) and the major axis (e.g., 531-1) or minor axis (e.g., 531-2) is used to characterize the elliptical contact area. For example, angle 535, which represents an angle between minor axis 531-2 and horizontal axis 533, is used to characterize the elliptical contact area (e.g., angle 535 may range from 0 degree to 180 degrees). In some embodiments, instead of the major axis or the minor axis, another axis (not shown) that is neither a major axis nor a minor axis is used to characterize the elliptical contact area.

In some embodiments, whether the finger contact is made with a thumb or a non-thumb finger is determined based an ellipticity (e.g., a ratio of a major axis length and a minor axis length) or eccentricity (e.g., a ratio of a major axis length and a distance between two foci) of the ellipse that is fitted to an area of the finger contact. In some embodiments, whether the finger contact is made with a thumb or a non-thumb finger is determined based on an area of the finger contact (e.g., a finger contact made with a thumb has a larger area than a finger contact made with a non-thumb finger). In some embodiments, a combination of methods described above may be used.

In some embodiments, a contact-area-to-coordinate-tuple conversion rule determines a finger contact coordinate tuple as a coordinate tuple that is offset from the centroid of the ellipse (e.g., 541). For example, finger contact coordinate tuple 547 is vertically offset from centroid 541 by a predetermined distance or in accordance with the area of contact 517. In some embodiments, a contact-area-to-coordinate tuple conversion rule determines a finger contact coordinate tuple as a coordinate tuple that is offset from the centroid of ellipse along the major axis (e.g., 541). In some embodiments, the amount of offset is determined based on a predetermined distance, in accordance with the area of contact 517 (e.g., the finger contact coordinate tuple may be offset by 30% of the major axis length of the ellipse that corresponds to contact 517), and/or based on the identity of the finger contact.

In some embodiments, contact-area-to-coordinate-tuple conversion rules are applied cumulatively (e.g., multiple contact-area-to-coordinate-tuple conversion rules can be used one after another). For example, a first contact-area-to-coordinate-tuple conversion rule determines a finger contact coordinate tuple as a centroid of the ellipse; a second contact-area-to-coordinate-tuple conversion rule offsets the coordinate tuple along the major axis of the ellipse by a predetermined distance; and a third contact-area-to-coordinate-tuple conversion rule offsets the coordinate tuple by a predetermined distance (in horizontal and/or vertical directions). Then, by applying the three contact-area-to-coordinate-tuple conversion rules, finger contact coordinate tuple 545 is determined (e.g., the first rule determines coordinate tuple 541 as the contact coordinate tuple; the second rule offsets coordinate tuple 541 to second coordinate tuple 543; and the third rule offsets second coordinate tuple 543 to coordinate tuple 545 (in accordance with horizontal offset 551 and vertical offset 553)). In some embodiments, respective conversion rules are represented as respective vectors, and the sum of vectors that corresponds to all applicable conversion rules are used to determine a respective finger contact coordinate tuple.

In some embodiments, contact-area-to-coordinate-tuple conversion rules are combinations of contact-area-to-coordinate-tuple conversion rules. For example, an index-finger-of-a-left-hand conversion rule may be a combination of a left-hand conversion rule and an index-finger conversion rule.

FIGS. 6A-6C are flow diagrams illustrating method 600 of determining respective finger contact coordinate tuples in accordance with some embodiments. Method 600 is performed at an electronic device (e.g., portable multifunction device 100, FIG. 1) with a touch-sensitive display and one or more touch-sensitive surfaces that are distinct from the touch-sensitive display (e.g., touch-sensitive surfaces on the bezel, sides, and/or back of the device). Some operations in method 600 may be combined and/or the order of some operations may be changed.

As described below, method 600 provides a more accurate way to determine respective finger contact coordinate tuples. The method reduces erroneous manipulations when manipulating one or more user interface objects, thereby reducing the cognitive burden on a user and creating a more efficient human-machine interface. For battery-operated computing devices, enabling a user to manipulate user interface objects faster and more efficiently conserves power and increases the time between battery charges.

The device displays (602) one or more user interface objects on the touch-sensitive display (e.g., user interface objects 502 and 504 in FIG. 5A).

The device detects (604) one or more user contacts (e.g., contacts 591, 593, and 595 in FIG. 5A) on the one or more touch-sensitive surfaces that are distinct from the touch-sensitive display (e.g., touch-sensitive surfaces 114 in FIGS. 1A-1B and 3A-3B). In some embodiments, user contacts may include finger contacts and/or contacts made by any other portion of the user's hand (e.g., palm, such as 593 in FIG. 5A) against the sides and/or back of the device.

Operations 608 through 612 are performed while the device detects the one or more user contacts on the one or more touch-sensitive surfaces that are distinct from the touch-sensitive display (606).

The device detects (608) one or more finger contact areas at respective locations on the touch-sensitive display (e.g., contact 505 in FIG. 5A).

For each finger contact area, the device determines (610) a respective finger contact coordinate tuple based at least in part on: a respective location of a respective finger contact area, and the user contacts on the one or more touch-sensitive surfaces that are distinct from the touch-sensitive display.

In some embodiments, determining the respective finger contact includes (616): determining an identity of a respective finger that corresponds to the respective finger contact area on the touch-sensitive display based at least in part on the detected user contacts on the one or more touch-sensitive surfaces that are distinct from the touch-sensitive display; selecting a contact-area-to-coordinate tuple conversion rule (e.g., 131 in FIGS. 1A-1B) in accordance with the identity of the respective finger; and determining the respective finger contact coordinate tuple in accordance with the respective location of the respective finger contact area and the selected contact-area-to-coordinate-tuple conversion rule. For example, in FIG. 5A, based on detected contacts 591, 593, and 595, device 100 determines that a left-hand is used to hold device 100, and that the identity of a finger that corresponds to contact 505 is a finger of a right hand. Then device 100 selects a finger-of-a-right-hand conversion rule.

In some embodiments, the finger is classified as either a thumb or a non-thumb finger (i.e., one of four digits in a hand that is not a thumb). In some embodiments, the finger is classified as one of: a thumb, an index finger, a middle finger, a ring finger, and a little finger. In some embodiments, the identity of the respective finger is determined also in accordance with a size and/or shape of a respective finger contact. For example, when the size of the respective finger exceeds a first threshold, the identity of the respective finger is determined to be a thumb. As another example, when the size of the respective finger is below a second threshold, the identity of the respective finger is determined to be a little finger. As yet another example, the identity of the respective finger is determined to be a thumb when the ellipticity of the contact area falls within a predefined range. In some embodiments, the identity of the respective finger is determined by a default rule (e.g., assume that an index finger is used to make a finger contact unless information is provided to identify the identity of the respective finger).

In some embodiments, determining the identity of the respective finger includes (618): determining a number of hands contacting the one or more touch-sensitive surfaces; and, when the number of hands contacting the one or more touch-sensitive surfaces is two, identifying the respective finger as a thumb (e.g., in FIG. 5D, when two hands are detected, the identity of a finger that corresponds to contact 511 is determined as a thumb).

In some embodiments, determining the identity of the respective finger includes (620): determining a number of hands contacting the one or more touch-sensitive surfaces; and, when a number of hands contacting the one or more touch-sensitive surfaces is one: determining an identity of a first hand contacting the one or more touch-sensitive surfaces; and identifying the respective finger as a finger of a second hand.

For example, if a left hand is contacting the touch-sensitive surfaces 114, device 100 uses a right-hand finger (or a finger-of-a-right-hand) conversion rule, because the gesture is deemed to be made with a right-hand finger and not the left thumb (e.g., in FIG. 5A, when device 100 determines that a left hand is holding device 100, the identity of a finger that corresponds to contact 505 is determined as a finger of a right hand). Analogously, when device 100 determines that a right hand is holding device 100, the identity of a finger that corresponds to a contact is determined as a finger of a left hand (not the right thumb), and a left-hand finger (or a finger-of-a-left-hand) conversion rule is selected.

In some embodiments, when the device determines that a single hand is holding the device, the device disregards contacts, if any, by the thumb of that single hand on the touch-sensitive display 112. This allows the device to prevent erroneous manipulations by that thumb.

In some embodiments, determining the identity of the respective finger on the touch-sensitive display includes (622) determining an identity of a hand associated with the respective finger. In some embodiments, determining the identity of a hand associated with the respective finger includes determining the identity of a hand holding the device (e.g., as noted above, if a left hand is holding the device, a right hand is used to make a contact; and vice versa).

In some embodiments, determining the respective finger contact coordinate tuple includes (624): selecting a contact-area-to-coordinate-tuple conversion rule (e.g., 131 in FIG. 1A) in accordance with the respective location of the respective finger contact area on the touch-sensitive display; and determining the respective finger contact coordinate tuple in accordance with the respective location of the respective finger contact area and the selected contact-area-to-coordinate tuple conversion rule. For example, if the contact is detected near the top of the touch-sensitive display, a first conversion rule is used (e.g., a contact-on-the-upper-part conversion rule configured for a contact near the top of the display); and if the contact is detected near the bottom of the touch-sensitive display, a second conversion rule is used (a contact-on-the-lower-part conversion rule configured for a contact near the bottom of the display). Selection of such a conversion rule based on a location of a contact can reduce touch targeting errors due to the difference between a perceived location of a contact on touch-sensitive display 112 and the actual location of the contact on touch-sensitive display 112.

In some embodiments, determining the respective finger contact coordinate tuple includes: determining a location of a hand that contacts the one or more touch-sensitive surfaces; selecting a contact-area-to-coordinate-tuple conversion rule (e.g., 131 in FIG. 1A) in accordance with the respective location of the hand that contacts the one or more touch-sensitive surfaces; and determining the respective finger contact coordinate tuple in accordance with the respective location of the respective finger contact area and the selected contact-area-to-coordinate tuple conversion rule. For example, when the holding hand is over the upper half of the device, the device selects a held-by-the-upper-part conversion rule. When the holding hand is over the lower half of the device, the device selects a held-by-the-lower-part conversion rule.

In some embodiments, determining a respective finger contact coordinate tuple includes (626): determining an orientation of a hand that contacts the one or more touch-sensitive surfaces that are distinct from the touch-sensitive display; selecting a contact-area-to-coordinate-tuple conversion rule (e.g., 131 in FIGS. 1A-1B) in accordance with the orientation of the hand that contacts the one or more touch-sensitive surfaces that are distinct from the touch-sensitive display; and determining the respective finger contact coordinate tuple in accordance with the respective location of the respective finger contact area and the selected contact-area-to-coordinate tuple conversion rule.

For example, if a hand is holding the device on a side edge, a conversion rule configured for a device held along the side edge is used. If the hand is holding the device along a bottom edge, a conversion rule configured for a device held along the bottom edge is used. In some embodiments, when device 100 determines that device 100 is held in a portrait orientation, a conversion rule configured for a portrait orientation is selected. In some embodiments, when device 100 determines that device 100 is held in a landscape orientation, a conversion rule configured for a landscape orientation is selected.

In some embodiments, determining the orientation of a hand includes determining an orientation of the device in accordance with the orientation of the hand (e.g., the hand is assumed to be located on a side of the device). In some embodiments, the orientation of the device is determined in accordance with the orientation of the hand and information received from accelerometer 168.

The device manipulates (612) at least one of the one or more user interface objects in accordance with the respective finger contact coordinate tuples. In some embodiments, manipulating at least one of the one or more user interface objects includes moving the at least one of the one or more user interface objects (e.g., with a drag gesture).

In some embodiments, manipulating at least one of the one or more user interface objects includes (614) activating at least one of the one or more user interface objects. For example, when the user interface object is an application launch icon (e.g., text 141, photos 144, camera 143, etc. in FIGS. 4A-4B), activating the user interface object includes launching an application that corresponds to the application launch icon (e.g., activating text 141 in FIG. 4A launches an instant messaging application or instant messaging module 141 in FIG. 1A). As another example, when the user interface object is a digital image icon (e.g., a photo icon), activating the user interface object includes displaying a digital image that corresponds to the digital image icon. As another example, when the user interface object is a music icon or a multimedia file icon, activating the user interface object includes playing a corresponding music file or a corresponding multimedia file. As another example, when the user interface objects are keys in a virtual keyboard, activating the user interface objects includes activating keys in the virtual keyboard.

In some embodiments, the device determines the number of fingers contacting the touch-sensitive display and the number of fingers contacting the touch-sensitive surfaces. When the number of fingers contacting the touch-sensitive display is more than the number of fingers contacting the touch-sensitive surfaces, the device ignores the finger contact areas detected on the touch-sensitive display.

In some embodiments, the device determines a contact made with a palm on the touch-sensitive display. When a contact is made with a palm on the touch-sensitive display, the device disregards the palm contact area detected on the touch-sensitive display. This allows the device to prevent erroneous manipulations by the palm contact.

The operations in the information processing methods described above may be implemented by running one or more functional modules in information processing apparatus such as general purpose processors or application specific chips. These modules, combinations of these modules, and/or their combination with general hardware (e.g., as described above with respect to FIGS. 1A, 1B and 3) are all included within the scope of protection of the invention.

The operations described above with reference to FIGS. 6A-6C may be implemented by components depicted in FIGS. 1A-1C. For example, detection operation 604, manipulation operation 612, and activation operation 614 may be implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 may utilize or call data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1C.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
at an electronic device with a touch-sensitive display and one or more touch-sensitive surfaces that are distinct from the touch-sensitive display:
displaying one or more user interface objects on the touch-sensitive display;
detecting one or more user contacts on the one or more touch-sensitive surfaces that are distinct from the touch-sensitive display;
while detecting the one or more user contacts on the one or more touch-sensitive surfaces that are distinct from the touch-sensitive display:
detecting one or more finger contact areas at respective locations on the touch-sensitive display;
for each finger contact area, determining a respective finger contact coordinate tuple based at least in part on:
a respective location of a respective finger contact area, and
the user contacts on the one or more touch-sensitive surfaces that are distinct from the touch-sensitive display; and
manipulating at least one of the one or more user interface objects in accordance with the respective finger contact coordinate tuples.

2. The method of claim 1, wherein manipulating at least one of the one or more user interface objects includes activating at least one of the one or more user interface objects.

3. The method of claim 1, wherein determining the respective finger contact coordinate tuple includes:
determining an identity of a respective finger that corresponds to the respective finger contact area on the touch-sensitive display based at least in part on the detected user contacts on the one or more touch-sensitive surfaces that are distinct from the touch-sensitive display;
selecting a contact-area-to-coordinate-tuple conversion rule in accordance with the identity of the respective finger; and
determining the respective finger contact coordinate tuple in accordance with the respective location of the respective finger contact area and the selected contact-area-to-coordinate-tuple conversion rule.

4. The method of claim 3, wherein determining the identity of the respective finger includes:
determining a number of hands contacting the one or more touch-sensitive surfaces; and,
when the number of hands contacting the one or more touch-sensitive surfaces is two, identifying the respective finger as a thumb.

5. The method of claim 3, wherein determining the identity of the respective finger includes:
determining a number of hands contacting the one or more touch-sensitive surfaces; and,
when the number of hands contacting the one or more touch-sensitive surfaces is one:
determining an identity of a first hand contacting the one or more touch-sensitive surfaces; and
identifying the respective finger as a finger of a second hand.

6. The method of claim 3, wherein determining the identity of the respective finger includes determining an identity of a hand associated with the respective finger.

7. The method of claim 1, wherein determining the respective finger contact coordinate tuple includes:
selecting a contact-area-to-coordinate-tuple conversion rule in accordance with the respective location of the respective finger contact area on the touch-sensitive display; and
determining the respective finger contact coordinate tuple in accordance with the respective location of the respective finger contact area and the selected contact-area-to-coordinate-tuple conversion rule.

8. The method of claim 1, wherein determining a respective finger contact coordinate tuple includes:
determining an orientation of a hand that contacts the one or more touch-sensitive surfaces that are distinct from the touch-sensitive display;
selecting a contact-area-to-coordinate-tuple conversion rule in accordance with the orientation of the hand that contacts the one or more touch-sensitive surfaces that are distinct from the touch-sensitive display; and
determining the respective finger contact coordinate tuple in accordance with the respective location of the respective finger contact area and the selected contact-area-to-coordinate-tuple conversion rule.

9. An electronic device, comprising:
a touch-sensitive display;
one or more touch-sensitive surfaces that are distinct from the touch-sensitive display;
one or more processors;
memory; and
one or more programs, wherein the one or more programs are stored in the memory and configured to be executed by the one or more processors, the one or more programs including instructions for:
displaying one or more user interface objects on the touch-sensitive display;
detecting one or more user contacts on the one or more touch-sensitive surfaces that are distinct from the touch-sensitive display;
while detecting the one or more user contacts on the one or more touch-sensitive surfaces that are distinct from the touch-sensitive display:
detecting one or more finger contact areas at respective locations on the touch-sensitive display;
for each finger contact area, determining a respective finger contact coordinate tuple based at least in part on:
a respective location of a respective finger contact area, and
the user contacts on the one or more touch-sensitive surfaces that are distinct from the touch-sensitive display; and
manipulating at least one of the one or more user interface objects in accordance with the respective finger contact coordinate tuples.

10. The device of claim 9, wherein instructions for manipulating at least one of the one or more user interface objects includes instructions for activating at least one of the one or more user interface objects.

11. The device of claim 9, wherein instructions for determining the respective finger contact coordinate tuple include instructions for:
determining an identity of a respective finger that corresponds to the respective finger contact area on the touch-sensitive display based at least in part on the detected user contacts on the one or more touch-sensitive surfaces that are distinct from the touch-sensitive display;
selecting a contact-area-to-coordinate-tuple conversion rule in accordance with the identity of the respective finger; and
determining the respective finger contact coordinate tuple in accordance with the respective location of the respective finger contact area and the selected contact-area-to-coordinate-tuple conversion rule.

12. The device of claim 11, wherein instructions for determining the identity of the respective finger include instructions for:
determining a number of hands contacting the one or more touch-sensitive surfaces; and,
when the number of hands contacting the one or more touch-sensitive surfaces is two, identifying the respective finger as a thumb.

13. The device of claim 11, wherein instructions for determining the identity of the respective finger include instructions for:
determining a number of hands contacting the one or more touch-sensitive surfaces; and,
when the number of hands contacting the one or more touch-sensitive surfaces is one:
determining an identity of a first hand contacting the one or more touch-sensitive surfaces; and
identifying of the respective finger as a finger of a second hand.

14. The device of claim 12, wherein instructions for determining the identity of the respective finger include instructions for determining an identity of a hand associated with the respective finger.

15. The device of claim 9, wherein instructions for determining the respective finger contact coordinate tuple include instructions for:
selecting a contact-area-to-coordinate-tuple conversion rule in accordance with the respective location of the respective finger contact area on the touch-sensitive display; and
determining the respective finger contact coordinate tuple in accordance with the respective location of the respective finger contact area and the selected contact-area-to-coordinate-tuple conversion rule.

16. The device of claim 9, wherein instructions for determining a respective finger contact coordinate tuple include instructions for:
determining an orientation of a hand that contacts the one or more touch-sensitive surfaces that are distinct from the touch-sensitive display;
selecting a contact-area-to-coordinate-tuple conversion rule in accordance with the orientation of the hand that contacts the one or more touch-sensitive surfaces that are distinct from the touch-sensitive display; and
determining the respective finger contact coordinate tuple in accordance with the respective location of the respective finger contact area and the selected contact-area-to-coordinate-tuple conversion rule.

17. A computer readable storage medium storing one or more programs, the one or more programs comprising instructions, which when executed by one or more processors of an electronic device with a touch-sensitive display and one or more touch-sensitive surfaces that are distinct from the touch-sensitive display, cause the device to:
display one or more user interface objects on the touch-sensitive display;
detect one or more user contacts on the one or more touch-sensitive surfaces that are distinct from the touch-sensitive display;
while detecting the one or more user contacts on the one or more touch-sensitive surfaces that are distinct from the touch-sensitive display:
detect one or more finger contact areas at respective locations on the touch-sensitive display;
for each finger contact area, determine a respective finger contact coordinate tuple based at least in part on:
a respective location of a respective finger contact area, and
the user contacts on the one or more touch-sensitive surfaces that are distinct from the touch-sensitive display; and
manipulate at least one of the one or more user interface objects in accordance with the respective finger contact coordinate tuples.

18. The computer readable storage medium of claim 17, wherein instructions for determining the respective finger contact coordinate tuple include instructions for:
determining an identity of a respective finger that corresponds to the respective finger contact area on the touch-sensitive display based at least in part on the detected user contacts on the one or more touch-sensitive surfaces that are distinct from the touch-sensitive display;
selecting a contact-area-to-coordinate-tuple conversion rule in accordance with the identity of the respective finger; and
determining the respective finger contact coordinate tuple in accordance with the respective location of the respective finger contact area and the selected contact-area-to-coordinate-tuple conversion rule.

19. The computer readable storage medium of claim 17, wherein instructions for determining the respective finger contact coordinate tuple include instructions for:
selecting a contact-area-to-coordinate-tuple conversion rule in accordance with the respective location of the respective finger contact area on the touch-sensitive display; and
determining the respective finger contact coordinate tuple in accordance with the respective location of the respective finger contact area and the selected contact-area-to-coordinate-tuple conversion rule.

20. The computer readable storage medium of claim 17, wherein instructions for determining a respective finger contact coordinate tuple include instructions for:
determining an orientation of a hand that contacts the one or more touch-sensitive surfaces that are distinct from the touch-sensitive display;
selecting a contact-area-to-coordinate-tuple conversion rule in accordance with the orientation of the hand that contacts the one or more touch-sensitive surfaces that are distinct from the touch-sensitive display; and
determining the respective finger contact coordinate tuple in accordance with the respective location of the respective finger contact area and the selected contact-area-to-coordinate-tuple conversion rule.
